(19) United States
(12) Patent Application Publication
(10) Pub. No.: US 2007/0282495 A1
(43) Pub. Date: Dec. 6, 2007

(54) SYSTEM AND METHOD FOR ASSESSING VEHICLE TO GRID (V2G) INTEGRATION

(75) Inventors: Willett Kempton, Newark, DE (US); Jasna Tomic', Newark, DE (US)

Correspondence Address: CONNOLLY BOVE LODGE & HUTZ LLP, 1875 EYE STREET, N.W., SUITE 1100, WASHINGTON, DC, 20036, US

(73) Assignee: UNIVERSITY OF DELAWARE, Newark, DE (US)

(21) Appl. No.: 11/742,882

(22) Filed: May 1, 2007

Related U.S. Application Data
(60) Provisional application No. 60/747,050, filed on May 11, 2006.

(51) Int. Cl. G06F 17/00

(52) U.S. Cl. 701/22; 180/65.1

(57) ABSTRACT

A method for calculating power available for sale from an electric vehicle to an electric power market on a grid includes determining maximum DC power available from the electric vehicle; determining an electrical conversion efficiency related to a conversion of DC power from the electric vehicle to AC power; accounting for a time period in which the DC power is available from the electric vehicle; and calculating the power available for sale from the electric vehicle. A method of assessing economic value of a vehicle to grid arrangement includes calculating a total revenue amount due to providing one or more of peak power, spinning reserves, and regulation services; calculating a cost for each of producing energy, degradation due to wear, and annualized capitalization; summing the calculated costs; and determining the economic value of the vehicle to grid arrangement by comparing the summed calculated costs to the total revenue amount. A computer-implemented system for assessing economic value of a vehicle to grid arrangement includes a computer circuit configured to calculate a total revenue amount due to providing one or more of peak power, spinning reserves, and regulation services; calculate a cost for each of producing energy, degradation due to wear, and annualized capitalization; sum the calculated costs; and determine the economic value of the vehicle to grid arrangement by comparing the summed calculated costs to the total revenue amount.

### CROSS-REFERENCE TO RELATED APPLICATIONS

This application claims benefit under 35 USC § 119(e) to U.S. provisional application 60/747,050, filed on May 11, 2006, the entire contents of which are incorporated herein by reference.

### BACKGROUND

This disclosure relates to vehicle to grid (“V2G”) and grid to vehicle (“G2V”) power models for ancillary services (“AS”) and related electric grid support, and also to V2G integration of intermittent renewable energy including wind and solar electricity into the electric grid.

In one aspect, this disclosure is directed to a system and method to calculate the power capacity and revenues for electric-drive vehicles used to provide power for several power markets. This disclosure is further directed to placing vehicle-to-grid power within the existing electric system.

During the 20th century, industrialized countries developed two massive but separate energy conversion systems—the electric utility system and the light vehicle fleet. In the United States, for example, there are over 9351 electric utility generators with a total power capacity of 602 GW (plus 209 GW from non-utility generators). These generators convert stored energy (chemical, mechanical, and nuclear) to electric current, which moves through an interconnected national transmission and distribution grid. The second massive energy conversion system is the fleet of 176 million light vehicles (passenger cars, vans, and light trucks), which convert petrochemical energy to rotary motion, and then to travel. With a shaft power capacity averaging 149 hp, or 111 kWm per vehicle (kWm is kW mechanical), the US fleet's 176 million light vehicles have a total power capacity of 19,500 GWm or 19.5 TWm, which is 24 times the power capacity of the entire electric generation system. This energy from the light vehicle fleet offers possibilities for further exploitation which heretofore have not been implemented.

The automotive industry is beginning its shift to electric-drive vehicles (EDVs) (“electric-drive vehicles” use an electric motor to drive the wheels—whether the vehicle's electricity comes from a battery, a fuel cell, or a hybrid combining a gasoline engine with a generator).

The utility industry is beginning its shift to renewable energy, and these systems offer opportunities to converge in the early decades of the 21st century in that (1) the vehicle fleet will provide electricity storage and quick-response generation to the electric grid; (2) electricity will complement or displace liquid fuel as an energy carrier for a steadily increasing fraction of the vehicle fleet; and (3) automated controls will optimize power transfers between these two systems, taking into account their different but compatible needs for power by time-of-day.

The third form of integration, two-way flow of energy and information from distributed energy resources to the power grid, is envisioned by the Electric Power Research Institute's (EPRI) “Roadmap” that is being standardized in IEC 61850 as part of the Distributed Energy Resources Object Model (DER-OM) by IEC.

Table 1 compares the electric generation system with today's vehicle fleet, and with a hypothetical future fleet comprised of one-fourth EDVs (one-fourth is 44 million EDVs in a national fleet of 176 million light vehicles).

TABLE 1
Electric utility generation compared with the light vehicle fleet (for the US)

| | Electric generation | Current light vehicle fleet | Hypothetical fleet |
|---|---|---|---|
| Metric | system | (mechanical power) | with 25% EDVs |
| Number of units | 9351^{a} | 176,000,000^{f} | 44,000,000 |
| Average unit power | 64,000 | 111^{g} | 15^{k} |
| (kW) | | | |
| Total system power | 602^{b} | 19,500^{h} | 660 |
| (GW) | | | |
| In-use | 57%^{c} | 4%ⁱ | 4% |
| Response time (off to | Minutes to hours^{d} | Seconds | Milliseconds to seconds^{l} |
| full power) | | | |
| Design lifetime (h) | 80,000-200,000^{o} | 3000 | >3000 |
| Capital cost (per kW) | US$ 1000+ | US$ 60^{j} | US$ 10-200^{m} |
| Cost of electricity | .02-.09 average, | n.a. | .05-.50ⁿ |
| (US$/kWh) | .05-.80 peak^{e} | | |

^{a}From [6]; this table uses utility generators only because those figures are more complete. Non-utility generation is approximately another 209 GW capacity.
^{b}From [7].
^{c}3015 × 106 MWh/year [7] ÷ (602,000 MW × 365 days × 24 h per day) = 0.57.
^{d}Gas turbines about 10-15 min, large coal and nuclear several hours to 1 day.
^{e}We approximate cost via wholesale electricity trading in 1999 regional markets (most recent tabulation by EIA in US$/MWh converted to US$/kWh here). Monthly average prices on the PJM spot market ranged from 1.7 to 9.0 ¢/kWh. Each month's peak hour ranged from US$ .047 to 1.08/kWh, with peak hourly prices above 80 ¢/kWh for 5 of the 12 months. California and New England exchanges were in similar ranges [7].
^{f}From [3].
^{g}kW of mechanical power, e.g., 149 hp (111 kWm), based on average power of new light vehicles sold in 1993 [8]. The available sales-weighted horsepower figure for 1993 models is an imperfect approximation of the current fleet with an average age of 8 years.
^{h}176,000,000 units × 111 kWm per unit.
ⁱAverage time spent driving per driver is 59.5 min/day, the ratio of licensed drivers to vehicles is 1.0 [3], so vehicle in-use fraction is 59.5/(24 × 60) = 0.041, about 4%.
^{j}Cost per kWhm of drive train only, not whole vehicle [9].
^{k}Full-sized EDVs can generate bursts of 50-100 kW on-board, but we limit our analytical assumptions to just 15 kW due to limits on building wiring capacity. See Appendix A and [1].
^{l}Milliseconds for battery EDV, 1-2 s for hybrid or fuel cell EDV.
^{m}Incremental capital costs to add V2G to an EDV are given in [10], range reflects differences among battery, hybrid, and fuel cell vehicles. Formulae for calculating these figures are in [1]. Not included in this figure: capital cost of the vehicle itself is attributed to the transportation function; cost of additional wear on the vehicle due to V2G, which is calculated and included in the “cost of electricity” row of table.
ⁿCalculated from fuel consumption, losses, wear on the vehicle, and/or battery depletion [1, 11].
^{o}A gas turbine peaking plant might have a 20-year design lifetime, intended to be run 4000 h/year for design life of 80,000 h. A large coal plant with a design lifetime of 30 years, operated at 75% capacity factor or approximately 8000 h/year would have a lifetime of about 200,000 h [12, 7].

The electric grid and the light vehicle fleet are rarely analyzed together, or even measured with the same metrics. Table 1 puts the current vehicle fleet in the second data column for comparison, although of course the current fleet's dispersed mechanical shaft power cannot be transmitted or aggregated in any practical way. A hypothetical future fleet consisting of one-fourth EDVs is compared in the rightmost column of Table 1. One-fourth is used for illustration, because it could provide electrical power approximately equal to all US utility generation; it is also a plausible intermediate-term fraction to be electric drive. Table 1 shows that when just one-fourth of the US light vehicle fleet has converted to electric drive, it would rival the electricity generation power capacity of the entire utility system. Capital costs to tap vehicle electricity are one to two orders of magnitude lower than building power plants. The average per kWh cost of vehicle electricity is considerably higher and design lifetimes are one to two orders of magnitude lower, but the critical insight of our analysis is that vehicle electricity is competitive in specific electricity markets.

The three types of electric drive vehicles (EDVs) are: (1) fuel cell, which produces electricity on-board from a fuel, such as hydrogen, (2) battery, which stores power from the electric grid in an electrochemical cell, and (3) hybrid, which produces electricity on-board from an internal combustion engine turning a generator. Most relevant to V2G among the many possible hybrid designs is the “plug-in hybrid”, which has a grid connection, allowing recharge from the grid as well as from fuel, and larger electrical components to allow driving in electric-only mode.

The four power markets relevant to V2G are baseload, peak, spinning reserves, and regulation. Baseload power is the “bulk” power generation that is running most of the time. Peak power is used during times of predictable highest demand, for example, on hot summer afternoons, when maximum air conditioning is running. The other two forms of power are less well known. Spinning reserves are supplied by generators set-up and ready to respond quickly in case of failures (whether equipment failure or failure of a power supplier to meet contract requirements). They would typically be called, say, 20 times per year; a typical duration is 10 min but must be able to last up to 1 h (spinning reserves are the fastest-response and highest-value component of the more general electric market for “operating reserves”). Regulation is used to keep the frequency and voltage steady, they are called for only one up to a few minutes at a time, but might be called 400 times per day (again, terminology and operating rules vary somewhat across jurisdictions); spinning reserves and regulation are paid in part for just being available, a ‘capacity payment’ per hour available; baseload and peak are paid only per kWh generated. For the vehicle and power markets examined, that V2G (1) is not suitable for baseload power; (2) it may be suitable for peak power in some cases; (3) it is competitive for spinning reserves; (4) it is highly competitive for regulation. Continuous, bulk electricity can better be provided by large power plants because they last longer and cost less per kWh. But electric drive vehicles, with their fast response and low capital costs, appear to be a better match for the quick-response, short-duration, electric services, such as spinning reserves and regulation. These constitute, for example, in the US, 5-10% of electric generation costs, or about US $10 billion/year. A future form of electricity provision, not now formalized into separate markets, is storage and backup power for renewable energy. The needed storage differs depending on the type of renewable energy. Solar energy has a fairly regular diurnal cycle, and solar energy output peaks roughly 4 h before peak load demand. Wind energy is more erratic, less predictable, and more geographically determined; any one site may be low for several days, but a group of sites over a larger area is steadier. These renewable energy backup characteristics are analyzed in this article and matched to V2G.

What is needed is a system and method for determining the economics of vehicle to grid (“V2G”) and grid to vehicle (“G2V”) power, and a system and method for assisting in making pricing and power availability decisions related thereto.

### SUMMARY

We conducted technical analysis to understand the capacity of vehicles to provide power with minimal compromise of their primary function, transportation. We also investigated four major electricity markets, to find the best match of vehicle types to electric markets. To investigate these quantitatively, we developed equations to describe the available power and duration, and the costs and market value of these forms of power. The result we offer is a quantitative understanding of how electric drive vehicles can become part of the electrical grid, and methods for estimating the expected revenue and costs. Our conclusions suggest that electric drive vehicles probably will not generate bulk power, both because of their fundamental engineering characteristics and because our calculated per kWh cost of energy from vehicles is higher than bulk electricity from centralized generators.

V2G most strongly competes for electricity when there is a capacity payment to be on line and available, with an added energy payment when power is actually dispatched. This is the case for the ancillary service markets of spinning reserves and regulation. For these markets, even if V2G power loses money on each kWh sold, it can more than make up for that with the capacity payment. V2G may be able to compete when paid only for energy, but only when electricity prices are unusually high, as in some peak power markets. Existing electricity markets have been the focus of this article, because their prices are known and they offer a multibillion dollar annual revenue stream to help move V2G innovations forward. In the process, V2G would improve the reliability and reduce the costs of the electric system. As V2G begins to saturate these high value markets, it will be positioned to play a more fundamental role—storage for the emerging 21 st century electric system based primarily on intermittent renewable energy sources.

In a broad comparison of two immense energy conversion systems, finding the electric grid and electric automobiles surprisingly complementary. The electric grid has high capital costs and low production costs; the automobile fleet is the reverse. Electric generators are in use 57% of the time, automobiles only 4%. The electric grid has no storage; the automobile fleet inherently must have storage to meet its transportation function. Based on the contrasts between these systems, we lay out management strategies, business models, and three steps for a transition to V2G.

We suggest that in the short-term, electric-drive vehicles should be tapped for high-value, time critical services—regulation and spinning reserves—which can be served by about 3% of the fleet. As those markets are saturated, V2G can begin to serve markets for peak power and storage for renewable electric generation. Envisioning a longer-term role for V2G, with perhaps one-fourth to one-half of the fleet serving as backup generation and storage for renewable energy, leads us to the following reconceptualization of the entire energy system.

The fossil-fueled vehicle fleet and the mostly fossil-fueled electric power system, today taken for granted, increasingly appear circumscribed by the assumptions of the 20th century. For environmental and resource reasons, and eventually for economic ones as well, we expect that the 21st century will see fossil fuels displaced by intermittent renewable energy. Intermittent renewable resources will prove cheap and abundant, but present the problems of variation in strength through time and not being matched to load variation.

Contemplating a future based primarily on intermittent renewable resources forces us to recognize that fossil fuels have been not only an energy source, but also a high-density energy storage medium. Whether an automobile's US $50 sheet metal tank storing 300 miles of range, or a coal plant's piles to be burned only when electricity is needed, energy storage has been practically free. Storage has been a side benefit of our habit of carrying energy as molecules rather than electrons. We believe that those days are numbered. While future vehicles will always require storage to perform their function, future electric generation will no longer come with free storage.

The long-term case for V2G boils down to making a decision to keep the electric system and vehicle fleet separate, in which case we substantially increase the cost of renewable energy because we have to build storage to match intermittent capacity, or whether we can connect the vehicle and electric power systems intelligently, using the vast untapped storage of an emerging electric-drive vehicle fleet to serve the electric grid. Our work indicates that the latter alternative will be compelling by offering a path to reliable high-penetration renewable electricity as well a path to a low pollution vehicle fleet independent from petroleum. The prospect of V2G is to carry us along both these paths together, more quickly and economically than has been thought possible when planning either system in isolation.

### BRIEF DESCRIPTION OF THE DRAWINGS

FIG. 1 illustrates a schematic of proposed power line and wireless control connections between vehicles and the electric power grid;

FIG. 2 illustrates a shortfall of energy as percent of wind capacity in 342 events during a year; we assume a contract for firm capacity at 20% of the wind turbines' rated capacity. Based on Archer data on eight connected wind sites (100% shortfall=1 MWh/1MW=1 hMBSR).

FIG. 3 notionally depicts a computer-based system that may be used to aid in carrying out the method.

### DETAILED DESCRIPTION

The electric power grid and light vehicle fleet are exceptionally complementary as systems for managing energy and power. The power grid has essentially no storage (other than its 2.2% capacity in pumped storage), so generation and transmission must be continuously managed to match fluctuating customer load. This is now accomplished primarily by turning large generators on and off, or ramping them up and down, some on a minute-by-minute basis. By contrast, the light vehicle fleet inherently must have storage, since a vehicle's prime mover and fuel must be mobile.

Vehicles are designed to have large and frequent power fluctuations, since that is in the nature of roadway driving. The high capital cost of large generators motivates high use (average 57% capacity factor). By contrast, personal vehicles are cheap per unit of power and are utilized only 4% of the time for transportation, making them potentially available the remaining 96% of time for a secondary function. A comparison of the electric system with the light vehicle fleet becomes of practical interest as society contemplates electric-drive vehicles (EDVs), that is, vehicles with an electric-drive motor powered by batteries, a fuel cell, or a hybrid drive train. EDVs can generate or store electricity when parked, and with appropriate connections can feed power to the grid—known as vehicle-to-grid power or V2G power. The relatively lower capital costs of vehicle power systems and the low incremental costs to adapt EDVs to produce grid power suggest economic competitiveness with centralized power generation. On the other hand, compared with large generators, vehicles have low durability (about 1/50 of the design operating hours) and high cost per kWh of electric energy, suggesting that V2G power should be sold only to high-value, short-duration power markets. These power markets include regulation, spinning reserves, and peak power.

The basic concept of vehicle-to-grid power is that EDVs provide power to the grid while parked. The EDV can be a battery-electric vehicle, fuel cell vehicle, or a plug-in hybrid. Battery EDVs can charge during low demand times and discharge when power is needed. Fuel cell EDVs generate power from liquid or gaseous fuel. Plug-in hybrid EDVs can function in either mode. Each vehicle must have three required elements: (1) a connection to the grid for electrical energy flow, (2) control or logical connection necessary for communication with the grid operator, and (3) controls and metering on-board the vehicle. These elements vary somewhat with the business model.

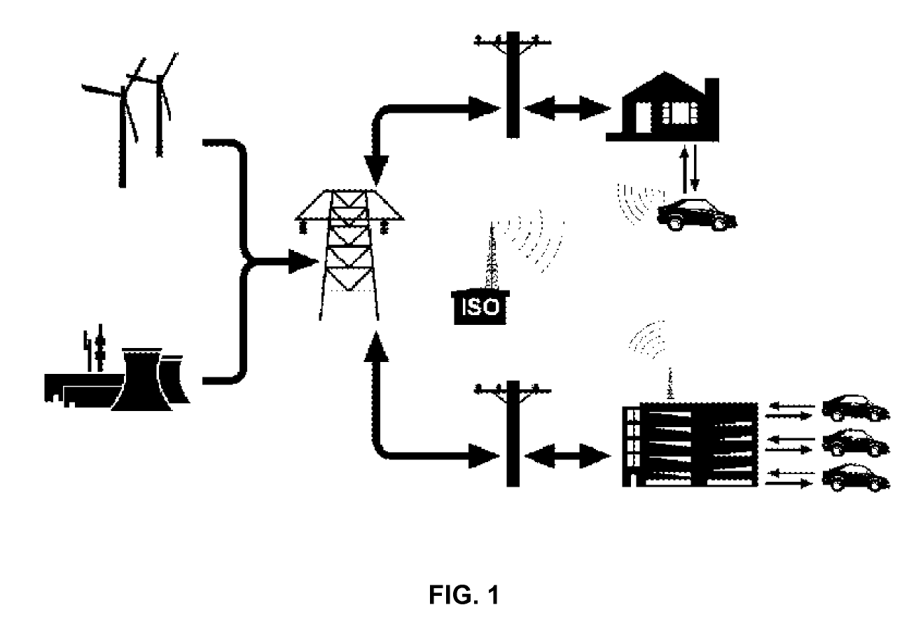

FIG. 1 schematically illustrates connections between vehicles and the electric power grid. Electricity flows one-way from generators through the grid to electricity users. Electricity flows back to the grid from EDVs, or with battery EDVs, the flow is two ways (shown in FIG. 1 as lines with two arrows). The control signal from the grid operator (labeled ISO, for Independent System Operator) could be a broadcast radio signal, or through a cell phone network, direct Internet connection, or power line carrier. In any case, the grid operator sends requests for power to a large number of vehicles. The signal may go directly to each individual vehicle, schematically in the upper right of FIG. 1, or to the office of a fleet operator, which in turn controls vehicles in a single parking lot, schematically shown in the lower right of FIG. 1, or through a third-party aggregator of dispersed individual vehicles' power (not shown). (The grid operator also dispatches power from traditional central-station generators using a voice telephone call or a T1 line, not shown in FIG. 1.)

Three types of EDVs are relevant to the V2G concept: (1) battery, (2) fuel cell, and (3) hybrid. All are EDVs, meaning that they use an electric motor to provide all or part of the mechanical drive power. All but the smallest EDV electric motors are driven by power electronics with sinusoidal AC at varying frequencies, with the capability of being set to the grid's 60 Hz. Thus, most of the power conditioning needed for grid power is already built-in and paid for as part of the transportation function. (Very small electric vehicles, such as a typical golf cart or neighborhood electric vehicle, typically use direct current motors and would require substantial additional power electronics to provide 60 Hz AC.)

Battery vehicles store energy electrochemically in the batteries, with lead-acid currently cheapest, but with nickel metal-hydride (NiMH), lithium-ion, and lithium-metalpolymer batteries becoming more competitive due to longer cycle life, smaller size and lower weight. Operationally, they plug in to charge their batteries and unplug to drive. Battery vehicles must have grid connections for charging, so the incremental costs and operational adjustments to add V2G are minimal.

Fuel cell EDVs typically store energy in molecular hydrogen (H₂), which feeds into a fuel cell along with atmospheric oxygen, producing electricity with heat and water as by-products. Multiple options for on-board storage or production of hydrogen are under development, including pressurizing the H₂ gas, binding it to metals, and on-board production of H₂ from natural gas, methanol, gasoline or another fuel. Currently, distribution infrastructure, on-board storage of hydrogen, and conversion losses are all substantial problems that leave open the question as to whether fuel cell light vehicles will be practical and cost-effective. Fuel cell EDVs used for V2G would produce electricity from the fuel cell, converted to 60 Hz AC by the on-board power electronics, and supplied to the grid. Any cost of grid connection is outside the transportation function, so in this analysis, the cost and driver inconvenience of plugging in a fuel cell vehicle are attributed to V2G costs.

Contemporary hybrid vehicles use an internal combustion (IC) engine whose shaft drives a generator. A small battery buffers the generator and absorbs regenerative braking. The battery and generator power one or more electric motors that drive the wheels, possibly in conjunction with direct shaft power from the IC engine. More conceptually, a hybrid has one power system with large energy storage—for range—and a second with high power output and discharge-recharge capability—for acceleration and regenerative braking. For simplicity, we discuss here only the contemporary hybrids with internal combustion engine and battery, although the principles and equations we develop apply to any hybrid type. The hybrids being mass-produced at the of this disclosure (the Toyota Prius, Honda Insight, and Civic hybrid) have much larger mechanical than electric drive power (approximately 75-25%), small batteries (1-2 kWh) and no electrical connection to the grid. This combination makes today's most-common hybrids impractical for V2G power. The coming “plug-in hybrid” makes two important additions: an enlarged battery and an electric plug to recharge [5], like the preproduction DaimlerChrysler Sprinter. The larger battery (6 kWh or more) allows running in all-electric mode for at least 20 miles, a mode having advantages of lower fuel cost, home refueling convenience, and zero tailpipe emissions.

In relation to V2G, the plug-in hybrid has a grid connection for its transportation function and a large enough battery to provide V2G from the battery alone. The plug-in hybrid can provide V2G either as a battery vehicle (that is, not using the IC engine when doing V2G), or as a motor-generator (using fuel while parked to generate V2G electricity).

Electricity is grouped in several different markets with correspondingly different control regimes. Here we discuss four of them—baseload power, peak power, spinning reserves, and regulation—which differ in control method, response time, duration of the power dispatch, contract terms, and price. We focus particularly on spinning reserves and regulation, which must deliver power within minutes or seconds of a request. All these electricity resources are controlled in real-time by either an integrated electric utility or an Independent System Operator—to refer to either of these parties here we use the simpler term “grid operator.” Further, there is an additional near future electricity market, storage of renewable energy, which can be approximated as combinations of the existing markets, discussed below. The terminology and specifics of grid control differ across countries and even across jurisdictions within federalized countries. Although this disclosure draws on US standards, markets, and terminology, the same basic types of control and power response are needed in any large power grid.

Baseload power is provided round-the-clock. In the US this typically comes from large nuclear or coal-fired plants that have low costs per kWh. Baseload power is typically sold via long term contracts for steady production at a relatively low per kW price.

V2G has been studied across multiple markets, showing that EDVs cannot provide baseload power at a competitive price. This is because baseload power hits the weaknesses of EDVs—limited energy storage, short device lifetimes, and high energy costs per kWh—while not exploiting their strengths—quick response time, low standby costs, and low capital cost per kW.

Peak power is generated or purchased at times of day when high levels of power consumption are expected—for example, on hot summer afternoons. Peak power is typically generated by power plants that can be switched on for shorter periods, such as gas turbines. Since peak power is typically needed only a few hundred hours per year, it is economically sensible to draw on generators that are low in capital cost, even if each kWh generated is more expensive. V2G peak power may be economic under some circumstances. The required duration of peaking units can be 3-5 h, which for V2G is possible but difficult due to on-board storage limitations. Vehicles could overcome this energy-storage limit if power was drawn sequentially from a series of vehicles, or if there were home refueling options, e.g., with natural gas.

Spinning reserves refers to additional generating capacity that can provide power quickly, say within 10 min, upon request from the grid operator. Generators providing spinning reserves run at low or partial speed and thus are already synchronized to the grid. (Spinning reserves are the fastest response, and thus most valuable, type of operating reserves; operating reserves are “extra generation available to serve load in case there is an unplanned event such as loss of generation”.) Spinning reserves are paid for by the amount of time they are available and ready.

For example, a 1 MW generator kept “spinning” and ready during a 24-h period would be sold as 1 MW-day, even though no energy was actually produced. If the spinning reserve is called, the generator is paid an additional amount for the energy that is actually delivered (e.g., based on the market-clearing price of electricity at that time). The capacity of power available for 1 h has the unit MW-h (meaning 1 MW of capacity is available for 1 h) and should not be confused with MWh, an energy unit that means 1 MW is flowing for 1 h. These contract arrangements are favorable for EDVs, since they are paid as “spinning” for many hours, just for being plugged in, while they incur relatively short periods of generating power. Contracts for spinning reserves limit the number and duration of calls, with 20 calls per year and 1 h per call typical maxima. As spinning reserves dispatch time lengthens, from the typical call of 10 min to the longest contract requirement, 2 h, fueled vehicles gain advantage over battery vehicles because they generally have more energy storage capacity and/or can be refueled quickly for driving if occasionally depleted by V2G. Spinning reserves, along with regulation (discussed below), are forms of electric power referred to as “ancillary services” or A/S. Ancillary services account for 5-10% of electricity cost, or about $12 billion per year in the U.S., with 80% of that cost going to regulation.

Regulation, also referred to as automatic generation control (AGC) or frequency control, is used to fine-tune the frequency and voltage of the grid by matching generation to load demand. Regulation must be under direct real-time control of the grid operator, with the generating unit capable of receiving signals from the grid operator's computer and responding within a minute or less by increasing or decreasing the output of the generator. Depending on the electricity market and grid operator, regulation may overlap or be supplemented by slower adjustments, including “balancing service” (intrahour and hourly) and/or “load following.” Although we have focused on regulation, V2G may be appropriate for some of these other services.

Some markets split regulation into two elements: one for the ability to increase power generation from a baseline level, and the other to decrease from a baseline. These are commonly referred to as “regulation up” and “regulation down”, respectively. For example, if load exceeds generation, voltage and frequency drop, indicating that “regulation up” is needed. A generator can contract to provide either regulation up, or regulation down, or both over the same contract period, since the two will never be requested at the same time. Markets vary in allowed combinations of up and down, for example, PJM Interconnect requires contracts for an equal amount of regulation up and down together, whereas California Independent System Operator (CAISO) is more typical in allowing contracts for just one, or for asymmetrical amounts (e.g., 1 MW up and 2 MW down).

Regulation is controlled automatically, by a direct connection from the grid operator (thus the synonym “automatic generation control”). Compared to spinning reserves, it is called far more often (say 400 times per day), requires faster response (less than a minute), and is required to continue running for shorter durations (typically a few minutes at a time). The actual energy dispatched for regulation is some fraction of the total power available and contracted for. We shall show that this ratio is important to the economics of V2G, so we define the “dispatch to contract” ratio as
R_{d-c}=E_{disp}/(P_{contr}t_{contr}) (1)
where R_{d-c} is the dispatch to contract ratio (dimensionless), E_{disp}the total energy dispatched over the contract period (MWh), P_{contr} the contracted capacity (MW), and t_{Contr} is the duration of the contract (h). R_{d-c} is calculated separately for regulation up or down.

We have found that this R_{d-c} is ratio is not tracked or recorded at least by six US utilities and grid operators, none of whom recorded it nor knew its approximate value; most could not easily provide the quantities needed to calculate it. We therefore resorted to calculating this ratio ourselves from a short period of intensively monitored data. Using data from CAISO of frequency regulation needed during the course of 1 day and modeling the response of one EDV, we obtained R_{d-c} of 0.08. We conservatively use 0.10 in our analysis (“conservative” because higher R_{d-c} increases the cost of V2G).

Three independent factors limit the amount of V2G power that a vehicle can provide: (1) the current-carrying capacity of the wires and other circuitry connecting the vehicle through the building to the grid, (2) the stored energy in the vehicle, divided by the time it is used, and (3) the rated maximum power of the vehicle's power electronics. The lowest of these three limits is the maximum power capability of the V2G configuration. We develop here analysis for factors 1 and 2, since they are generally much lower than 3. We shall first develop equations to calculate the limit on V2G by line capacity. Second, we develop equations to calculate the limit on V2G power by the vehicle's stored energy, divided by the dispatch time. We then calculate several examples of limits, using two vehicles, across the markets of regulation services, spinning reserves, and peak power.

Vehicle-internal circuits for full-function electric vehicles are typically upwards of 100 kW. For comparison, a US home maximum power capacity is typically 20-50 kW, with an average draw closer to 1 kW. To calculate the building-wiring maximum, one needs only the voltage and rated ampere capacity of the line:
Pₗᵢₙₑ=VA (2)
where Pₗᵢₙₑ is power limit imposed by the line in watts (here usually expressed in kW), V the line voltage, and A is the maximum rated current in amperes.

For example in the US, with home wiring at 240V AC, and a typical 50 A circuit rating for a large-current appliance such as an electric range, the power at the appliance is 50 A×240V, so Eq. (2) yields a line capacity of 12 kW maximum for this circuit. Based on typical US home circuits, some would be limited to 10 kW, others to 15 kW as the Pₗᵢₙₑ limit. For a commercial building, or a residential building after a home electrical service upgrade (at additional capital cost), the limit could be 25 kW or higher.

On the vehicle side, most existing (pre-V2G) battery vehicle chargers use the National Electrical Code (NEC) “Level 2” standard of 6.6 kW. The first automotive power electronics unit designed for V2G and in production, by AC Propulsion, provides 80 A in either direction, thus, by Eq. (2), 19.2 kW at a residence (240 V) or 16.6 kW at a commercial building (208 V).

The other limit on V2G power is the energy stored on-board, divided by the time it is drawn. More specifically, this limit is the onboard energy storage less energy used and needed for planned travel, times the efficiency of converting stored energy to grid power, all divided by the duration of time the energy is dispatched. This is calculated in Eq. (3)
P_{vehicle}=[[Eₛ−(d_{d}+d_{rb})/ηᵥₑₕ]ηᵢₙᵥ]/t_{disp} (3)
where P_{vehicle} is maximum power from V2G in kW, Eₛ the stored energy available as DC kWh to the inverter, d_{d} the distance driven in miles since the energy storage was full, d_{rb} the distance in miles of the range buffer required by the driver (explained below), ηᵥₑₕ the vehicle driving efficiency in miles/kWh, ηᵢₙᵥ the electrical conversion efficiency of the DC to AC inverter (dimensionless), and t_{disp} is time the vehicle's stored energy is dispatched in hours.

In a specific application of Eq. (3), d_{d} would depend on the driving pattern, the vehicle type (e.g., battery EDVs may be recharged at work), and the driver's strategies for being prepared to sell power. The value of d_{d} we use in examples here derives from an assumed average daily vehicle miles traveled per US driver of 32 miles. We assume here that half the average daily vehicle miles would have been depleted when the vehicle is parked and power is requested (i.e. d_{d}=16 miles). The d_{rb} refers to the “range buffer,” the minimum remaining range required by the driver. It is not an engineering measure of the vehicle but is specified by the driver or fleet operator who will determine d_{rb} based on, for example, the return commute or the distance reserved for an unanticipated trip to a convenience store or hospital. We use 20 miles for d_{rb} for battery and fuel cell vehicles; plug-in hybrids running V2G from their batteries can drain the battery and use fuel if driving is needed before recharge, so we assume d_{rb}=0 for plug-in hybrids.

The time dispatched (t_{disp}) will depend on the electricity market. For peak power, a reasonable value for t_{disp} is 4 h. For spinning reserves, although typical dispatches are 10 min, we calculate based on t_{disp}=1 h here to insure that a 1-h contract requirement can be met. For regulation up and down, power in a battery vehicle can flow both ways; although regulation dispatch is typically only 1-4 min, we use t_{disp} of 20 min to allow for the possibility of a long or repeated regulation up sequence. 1 The fuel cell vehicle, or hybrid in motor-generator mode, can provide only regulation up (power flows from vehicle to grid), not regulation down (power from grid to vehicle), so it has no analogy to the battery EDV's recharge during regulation down.

Thus, for example, a fuel cell vehicle parked 14 h and providing regulation up only, assuming R_{d-c} of 0.10, would have effective t_{disp}=1.4 h. Power capacity of V2G is determined by the lower of the two limits, Pₗᵢₙₑ or P_{vehicle}. We show how this is calculated for each type of vehicle: a battery EDV, the Toyota RAV4 EV, a plug-in hybrid, the preproduction DaimlerChrysler Sprinter, and a fuel cell EDV, the prototype Prodigy P2000. (There are newer examples of battery and fuel cell vehicles, e.g., the Volvo 3CC and Honda FCX, but our example vehicles are well documented and demonstrate the calculation methods.) The Toyota RAV4 EV has a NiMH battery with 27.4 kWh capacity, only 21.9 kWh of which we consider available (Es in Eq. (3)) because NiMH should not be discharged below 80% depth-of-discharge (DoD). The rated vehicle efficiency (ηᵥₑₕ) is 2.5 miles/kWh, and we assume an efficient inverter of ηᵢₙᵥ of 0.93. The plug-in hybrid is the Phase II preproduction DaimlerChrysler Sprinter, a 3.88-t panel van. The hybrid Sprinter will have gasoline or diesel options for the internal-combustion engine, plus a 14.4 kWh Saft Li-Ion battery pack. This battery can be discharged 100% without excessive damage. From a specified all-electric range of 30 km, we calculate electric driving efficiency of 1.33 miles/kWh. Here we assume V2G from the battery only; another operational V2G mode not calculated here would be running the motor-generator to generate power while the car is parked and plugged-in. The example fuel cell vehicle is the prototype Prodigy P2000. We assume the Ovonics metal hydride storage at 3.5 kg of H₂ rather than the Prodigy's 2 kg of compressed hydrogen. The 3.5 kg represent 116.5 kWh at the lower heating value, but with the P2000's 44% efficient fuel cell system Eₛ is equal to 51.3 kWh electricity available from storage. The vehicle efficiency (ηᵥₑₕ) is 2.86 miles/kWh.

The values for P_{vehicle} for different electricity markets for the two EDVs are calculated using Eq. (3) and listed in Table 2. For all vehicles, we assume d_{d} of 16 miles and an efficient inverter of ηᵢₙᵥ=0.93.

TABLE 2
Available power, P_{vehicle} from three EDV's at four dispatch times (t_{disp}),
calculated from Eq. (3)

| | Available power P_{vehicle} (kW) | | | |
|---|---|---|---|---|
| | Spin. | Reg. | Reg. up + down | Peak |
| | res. | up | (continuous | power |
| Vehicle type | (1 h) | (1.4 h) | per 0.33 h)^{a} | (4 h) |
| RAV4 EV (battery) | 7.0 | 5 | 21.0 + 21.4 | 1.75 |
| Sprinter (hybrid, | 2.2 | 1.6 | 6.6 + 40.5 | 0.55 |
| using battery | | | | |
| only) | | | | |
| P2000 (fuel cell, | 36.0 | 25.7 | — | 9.0 |
| added H₂ storage) | | | | |

^{a}Rather than Eq. (3), regulation down should be calculated as Eq. (3′): P_{vehicle} (d_{d}/ηᵥₑₕ − E_{recharge})/(η_{charger} t_{disp}), where η_{charger} is the efficiency of charger, and E_{recharge} is recharged kWh since plugging in. Here we assume η_{charger} = 0.9 and E_{recharge} = 0.

Several observations can be made from Table 2. The fuel cell vehicle can provide more power for spinning reserves and peak, whereas the battery and plug hybrid vehicles provide more for regulation because they provide both regulation up and down. For example, the RAV4 provides 21 kW regulation up plus 21 kW down, that is 42 kW of revenue from regulation; the P2000 provides 25.7 kW regulation up only.

Comparing the battery and plug-in hybrid, note that our assumed 16 miles of electric-mode driving almost exhaust the Sprinter's smaller battery capacity (given lower ηᵥₑₕ, and despite assuming d_{rb}=0). This leaves only 2.2 kW for 1 h spinning reserve. In some situations, such as V2G being used for wind backup, it is reasonable to assume advance notice on need for spinning reserves, so that hybrid driving could be done in constant-recharge mode, leaving full battery capacity available.

Available V2G power is the lesser of P_{vehicle}, from Table 2, and Pₗᵢₙₑ, from Eq. (2). If we assume a residential line limit of 15 kW, Table 2 shows that these battery and hybrid vehicles are limited by storage (P_{vehicle}) for spinning reserves and peak power, and by Pₗᵢₙₑ for regulation services. By contrast, the fuel cell vehicle has high P_{vehicle} values, as shown in Table 2, thus the assumed 15 kW Pₗᵢₙₑ would limit it for two of the three markets. (These limits in turn might motivate upgrade to a 20 or 25 kW line connection.)

The economic value of V2G is the revenue less the cost. Equations for each are derived below, followed by examples.

The formulas for calculating revenue depend on the market that the V2G power is sold into. For markets that pay only for energy, such as peak power and baseload power, revenue is simply the product of price and energy dispatched. This can also be expanded, since energy is P t,
r=pₑₗE_{disp}=pₑₗP_{disp}t_{disp} (4)
where r is the total revenue in any national currency (we use $ as a shorthand for the appropriate currency), pₑₗ the market rate of electricity in $/kWh, P_{disp} the power dispatched in kW (for peak power P_{disp} is equal to P, the power available for V2G), and t_{disp} is the total time the power is dispatched in hours. (Throughout, we shall use capital P for power and lower-case p for price.) On an annual basis, peak power revenue is computed by summing up the revenue for only those hours that the market rate (pₑₗ) is higher than the cost of energy from V2G (cₑₙ, discussed below).

For spinning reserves and regulation services the revenue derives from two sources: a “capacity payment” and an “energy payment.” The capacity payment is for the maximum capacity contracted for the time duration (regardless of whether used or not). For V2G, capacity is paid only if vehicles are parked and available (e.g., plugged-in, enough fuel or charge, and contract for this hour has been confirmed). The energy payment is for the actual kWh produced; this term is equivalent to Eq. (4). Eq. (5) calculates revenue from either spinning reserves or regulation services, with the first term being the capacity payment and the second term the energy payment.
r=(p_{cap}P t_{plug})+(pₑₗE_{disp}) (5)
where p_{cap} is the capacity price in $/kW-h, pₑₗ is the electricity price in $/kWh, P is the contracted capacity available (the lower of P_{vehicle} and Pₗᵢₙₑ), t_{plug} is the time in hours the EDV is plugged in and available, and E_{disp} is the energy dispatched in kWh. (Note that the capacity price unit, $/kW-h, means $ per kW capacity available during 1 h—whether used or not—whereas energy price units are the more familiar $/kWh.) For spinning reserves, E_{disp} can be calculated as the sum of dispatches,
E_{disp}=ΣᵢP_{disp}t_{disp}, for i=1,N_{disp} (6)
where N_{disp} is the number of dispatches, P_{disp} the power of each (presumably equal to the vehicle capacity P), and t_{disp} is the duration of each dispatch in hours. A typical spinning reserves contract sets a maximum of 20 dispatches per year and a typical dispatch is 10 min long, so the total E_{disp} will be rather small. For regulation services, there can be 400 dispatches per day, varying in power (P_{disp}). In production, these would likely be metered as net energy over the metered time period, E_{disp} in Eq. (5). For this article, to estimate revenue we approximate the sum of P_{disp} by using the average dispatch to contract ratio (R_{d-c}) defined by Eq. (1), and rearrange Eq. (6) as Eq. (7)
E_{disp}=R_{d-c}P t_{plug} (7)

Thus, for forecasting regulation services revenue (in a forecast, energy is estimated, not metered), Eq. (7) is substituted into Eq. (5), becoming Eq. (8),
r=p_{cap}P t_{plug}+pₑₗR_{d-c}P t_{plug} (8)

The cost of V2G is computed from purchased energy, wear, and capital cost. The energy and wear for V2G are those incurred above energy and wear for the primary function of the vehicle, transportation. Similarly, the capital cost is that of additional equipment needed for V2G but not for driving. Assuming an annual basis, the general formula for cost is
c=cₑₙE_{disp}+c_{ac} (9)
where c is the total cost per year, cₑₙ the cost per energy unit produced (calculated below), E_{disp} the electric energy dispatched in the year, and c_{ac} is the annualized capital cost (calculated below). For spinning reserves, again E_{disp} would be computed by Eq. (6) and used in Eq. (9) to obtain annual cost. For regulation, substituting Eq. (7) for E_{disp} into Eq. (9), the total annual cost to provide regulation is
c=cₑₙR_{d-c}P t_{plug}+c_{ac} (10)
where cₑₙ is the per kWh cost to produce electricity (also used in Eq. (9)). The equation for cₑₙ includes a purchased energy term and an equipment degradation term
cₑₙ=cₚₑ/η_{conv}+c_{d} (11)
where cₚₑ is the purchased energy cost, and c_{d} is the cost of equipment degradation (wear) due to the extra use for V2G, in $/kWh of delivered electricity. The purchased energy cost cₚₑ is the cost of electricity, hydrogen, natural gas, or gasoline, expressed in the native fuel cost units (e.g., $/kg H₂), and η_{conv} is the efficiency of the vehicle's conversion of fuel to electricity (or conversion of electricity through storage back to electricity). The units of η_{conv} are units of electricity per unit of purchased fuel. Thus Eq. (11)'s computed cₑₙ, the cost of delivering a unit of electricity, is expressed in $/kWh regardless of the vehicle's fuel. Degradation cost, c_{d}, is calculated as wear for V2G due to extra running time on a hybrid engine or fuel cell, or extra cycling of a battery. For a fuel cell vehicle or hybrid running in motor-generator mode, degradation cost is
c_{d}=c_{engine}/Lₕ (12)
where c_{engine} is the capital cost per kW of the engine or fuel cell, including replacement labor in $/kWh, and Lₕ is the engine or fuel cell lifetime in hours. The degradation cost, c_{d} is thus expressed in $/kWh. For a battery vehicle,
c_{d} is c_{d}=c_{bat}L_{ET} (13)
where c_{bat} is battery capital cost in $ (including replacement labor), and L_{ET} is battery lifetime throughput energy in kWh for the particular cycling regime (discussed below). The cost of degradation is zero if the vehicle life is less than the engine, fuel cell, or battery life due to driving plus V2G degradation, or if the battery's shelf life is reached before the degradation/wear life,
c_{d}=0 (14)

Battery lifetime is often expressed in cycles, measured at a specific depth-of-discharge. For Eq. (13), we express battery life in energy throughput, L_{ET}, defined as
L_{ET}=L_{c}EₛDoD (15)
where L_{c} is lifetime in cycles, Eₛ the total energy storage of the battery, and DoD is the depth-of-discharge for which L_{c} was determined.

Shallow cycling has less impact on battery lifetime than the more commonly reported deep cycling. For example, test data on a Saft lithium-ion battery show a 3000-cycle lifetime at 100% discharge, and a 1,000,000-cycle lifetime for cycling at 3% discharge. Using Eq. (15), the 3% cycle achieves 10 times the lifetime kWh throughput. Lead-acid and NiMH batteries produce similar results in that batteries at 3% DoD yield about 28 times the throughput as they do at 80% DoD.

Deep cycling approximates V2G battery use for peak power or spinning reserves at longer dispatches, whereas the 3% cycling is closer to that of regulation services. Here we base battery life parameters on 80% discharge test cycle for peak power or spinning reserves, and approximate lifetime energy throughput at three times that amount when V2G is used for regulation services. The three times approximation is conservative—the above data suggest a 10 times or greater increase in lifetime throughput at the low DoD cycling regimes. To make financial decisions, calculations are typically made on a yearly basis and capital cost is annualized. One way to annualize a single capital cost is to multiply it by the capital recovery factor (CRF) as expanded in Eq. (16)
c_{ac}=c_{c}CRF=c_{c}[d/(1−(1+d)⁻ⁿ)] (16)
where c_{ac} is the annualized capital cost in $/year, c_{c} the total capital cost in $, d the discount rate, and n is the number of years the device will last.

For a sample calculation of revenue and cost, we use the same RAV4 EV discussed earlier, providing regulation for the 2003 CAISO market. Revenue is calculated with Eq. (8). This vehicle's parameters for Eq. (8) are listed in Table 3 and described under “comments.” The last entry is the resulting computed revenue. The total annual revenue calculated by Eq. (8) then for the RAV4 is $4928, with $3942 from capacity payments and $986 from energy payments.

TABLE 3
Calculation of revenue from a RAV4 EV providing regulation

| Revenue | | |
|---|---|---|
| parameters | Value | Comments |
| P (kW) | 15 | Use Pₗᵢₙₑ because Pₗᵢₙₑ < P_{vehicle} (Table 1) |
| p_{cap} ($/kW-h) | 0.04 | CAISO 2003 market prices [28]: $ 0.02/kW-h |
| | | for regulation up capacity plus the same |
| | | for regulation down |
| pₑₗ ($/kWh) | 0.10 | Retail electricity price^{a} |
| t_{plug} (h/year) | 6570 | Assume vehicle plugged in 18 h daily, so |
| | | t_{plug} = 18 h/day × 365 day/year |
| R_{d-c} | 0.10 | See text with Eq. (1) |
| r ($) | 4928 | Revenue, result by Eq. (8) |

^{a}Retail electric rates are used on the RAV4 for revenue and subsequently for cost, so the net effect is paying retail for round-trip electrical losses.

Next we calculate costs for the RAV4 to provide regulation services, using the cost parameters in Table 4 and Eq. (10). As shown in Table 4, the annual cost for RAV4-provided regulation is $2374.

TABLE 4
Calculation of cost of a RAV4 EV providing regulation

| Cost parameters | Value | Comments |
|---|---|---|
| cₚₑ ($/kWh) | 0.10 | Assume purchase at retail electric cost |
| η_{sys} (%) | 73 | Round-trip electrical efficiency, grid- |
| | | battery-grid |
| c_{bat} ($) | 9890 | 350 ($/kWh)a × 27.4 $/kWh + 10 h |
| | | replacement labor × 30 ($/h) |
| c_{d} ($/kWh) | 0.075 | By Eq. (13) |
| cₑₙ ($/kWh) | 0.21 | Result by Eq. (11) |
| L_{ET} (kWh) | 131520 | This NiMH battery achieves 2000 |
| | | cycles under deep cycle testing |
| | | (EPRI 2003). By Eq. (11), L_{ET} = |
| | | 43840 kWh; for shallow DoD, we |
| | | assume 3 × L_{ET} (see text). |
| c_{c} ($) | 1900 | On-board incremental costs $ 400; |
| | | wiring upgrade $ 1500^{b} |
| c_{ac} ($/year) | 304 | Result by Eq. (16), assuming d = 10%; |
| | | n = 10 years, thus CRF = 0.16 |
| c ($) | 2374 | Cost, result by Eq. (10), assuming as |
| | | before P = 15 kW and t_{plug} = |
| | | 6570 h |

aAssuming annual production of 100,000 batteries per year, EPRI estimates $ 350/kWh.
^{b}If the plug capacity in a residence is to be greater than 6.6 kW, we assume wiring costs of $ 650 for 10 kW and $ 1500 for 15 kW. We assume custom, single-home costs and attribute the additional wiring costs to V2G costs, even though there would be transportation benefits such as fast charging. Wiring upgrades to a series of plugs in a parking structure or fleet lot would be far less, as would installation in new residences.

The net profit (revenue in Table 3 minus cost in Table 4) is $4928-2374 or $2554 a year. If we assume a 10 kW line rather than 15kW (at $650 incremental capital cost for wiring upgrade rather than $1500, the revenue is $3285, cost is $1554, and the net is $1731. Thus, the more expensive 15 kW wiring upgrade pays off quickly.

The second net revenue example is the fuel cell vehicle selling spinning reserves. We use the fuel cell vehicle in these examples because, as suggested in Table 2, the fuel cell vehicle is better matched to spinning reserves and peak power, the battery vehicle better matched to regulation. Values of the parameters in Eq. (5) are listed in Table 5 for this particular example. As shown in Table 5, the revenue for fuel cell vehicles selling spinning reserves is $699.

TABLE 5
Revenue from fuel cell vehicle providing spinning reserves

| Revenue | | |
|---|---|---|
| parameters | Value | Comments |
| P (kW) | 15 | Assume P = Pₗᵢₙₑ = P_{disp} |
| p_{cap} ($/kW-h) | 0.007 | CAISO spinning reserves market price |
| | | average for 2003 |
| pₑₗ ($/kWh) | 0.03 | Assumed average spot energy price |
| t_{plug} (h/year) | 6570 | Plugged in daily, 18 (h/day) × 365 |
| | | (day/year) |
| E_{disp} (kWh) | 300 | Assume 20 calls a year, each 15 kW for |
| | | 1 h, per Eq. (6) |
| r ($) | 699 | Revenue, result by Eq. (5) |

To calculate the annual costs for providing spinning reserves for the FC vehicles we use the values shown in Table 6, with Eqs. (9) and (11).

TABLE 6
Cost of fuel cell vehicle providing spinning reserves

| Cost parameters | Value | Comments |
|---|---|---|
| cₚₑ ($/kg H₂) | 5.6 | High of projected hydrogen cost range |
| cₚₑ ($/kg H₂) | 1.7 | Low of projected hydrogen cost range |
| η_{conv} (kWh/kg H₂) | 13.57 | For fuel cell, η_{conv} = η_{FC} ηᵢₙᵥ; η_{FC} = |
| | | 14.75 kWh/kg H₂; ηᵢₙᵥ = 0.92 |
| c_{d} ($/kWh) | 0.0025 | Mid-range of degradation estimates: |
| | | 33% over 10000 h, thus Lₕ = 30000 h; |
| | | capital cost c_{engine} = 75 $/kW |
| cₑₙ ($/kWh) | 0.42 | Per Eq. (11), high H₂ cost |
| cₑₙ ($/kWh) | 0.13 | Per Eq. (11), low H₂ cost |
| c_{ac} ($/year) | 399 | c_{c} = $ 2450 (see text); d = 10%; |
| | | n = 10 years; CRF = 0.16; Eq. (16) |
| c ($ (high)) | 525 | Cost, result by Eq. (9) |
| c ($ (low)) | 438 | Cost, result by Eq. (9) |

The capital costs are higher in this case because we assume that the transportation function of our example fuel cell vehicle would not require grid connection, thus the plug, wiring, and on-board connections must be charged entirely to the capital cost of V2G. We assume capital costs of $2450 which include on-board power electronics to synchronize the AC motor drive to 60 Hz and provide protection ($450), and wires and plug for grid connection ($200). On the building side, a 70 A, 240V (16.8 kW) connection with ground fault interrupt but not NEC 625 compliant (only flow to grid, not charging, is contemplated) could range $50-5000 at a residence, probably closer to $800 in a fleet garage. Here we assume $1800 on the building side, plus $450 on-board, for a total of $2450.

Amortized as shown by Eq. (12), this gives an annual value of c_{ac}=$399. The total annual cost based on Eq. (5) and the values in Table 5, using the high estimate for hydrogen, is $525. Thus, given the above assumptions, the net annual revenue is $174. At low H₂ costs, the total annual cost is $438 and the net is $262. These figures illustrate that this result is not very sensitive to projected hydrogen prices, nor to energy payments ($/kWh), because spinning reserves involve very little energy transfer. However, the result is very sensitive to the capacity price for spinning reserves. For example, the ERCOT market is one of the higher US prices for spinning reserves—at 2003 ERCOT price of $23/MW-h and again assuming the high end range of H₂ prices, the gross revenue is $2276 and the net annual revenue is $1751. More generally, fuel cell spinning reserves is economically viable only with a combination of good market prices and moderate capital costs; it is not sensitive to hydrogen costs.

In Table 6, the values of the parameter cₑₙ range from $0.13 to 0.42/kWh, depending on the assumed price of hydrogen. Since bulk power production is below $0.05/kWh, under our assumptions the fuel cell vehicle cannot compete with bulk power production from centralized plants. However, since peak power can be much more expensive per kWh, selling peak power may be economically viable despite its lack of a capacity payment.

The term “peak power” does not refer to a specific power market. Rather, it is used to refer to the highest cost hours of the year, when most or all generators are on-line and additional power is costly. A full analysis of the value of peak power requires stepping through hourly market values, assuming sales of V2G whenever the market value is above the cost of V2G and the vehicle is available, and summing the annual revenue. To provide a simpler calculation here as an example, we use an industry rule of thumb from central California, that there are 200 h in an average year when additional generation costs $0.50/kWh. Based on this and the data in Table 5, we give in Table 7 parameters for calculating the revenue and cost of a fuel cell vehicle providing peak power.

TABLE 7
Revenue and cost of fuel cell vehicle providing peak power

| Cost parameters | Value | Comments |
|---|---|---|
| cₚₑ ($/kg H₂) | 3.65 | Mid-range of hydrogen cost |
| cₑₙ ($/kgWh) | 0.27 | Per Eq. (11), with parameters from Table 5 |
| t_{disp} (h/year) | 200 | Rule of thumb: 200 h at $ 0.50/kWh |
| E_{disp} (kWh) | 3000 | 200 h at 15 kW, Eq. (6) |
| r ($) | 1500 | Revenue result, per Eq. (4) |
| c ($) | 1210 | Cost result, by Eq. (9) |

Thus the net revenue, based on Table 7, is $1500-1210, or $290, a positive annual net, but perhaps too small to justify transaction costs. This calculation is given only as an illustration. This result is highly dependent upon the cost of hydrogen (a mid-range projection was used here), the actual market prices for a representative year rather than the rule of thumb used here, and the match of peak time to vehicle availability.

Central to the viability of V2G are the needs and desired functions of the two human parties—the driver and the grid operator. The driver needs enough stored energy on-board (electric charge or fuel) for driving needs. The grid operator needs power generation to be turned on and off at precise times. Three strategies for V2G can resolve potential conflicts: (1) add extra energy storage to vehicle, (2) draw V2G from fleets with scheduled usage, and (3) use intelligent controls for complementary needs.

The first strategy, extra storage, is a “brute force” strategy. In this approach, the vehicle designer goes beyond the storage requirements for driving and adds on extra storage for grid support say more batteries or a larger H₂ tank. The problem is that extra storage on the vehicle increases cost and vehicle weight. Economically, the reason V2G makes sense is because the storage system is purchased for the transportation function, yet is idle 96% of the time. If storage must be added for V2G, 100% of the cost of that storage must be attributed to grid management, leaving little economic advantage of V2G over centralized storage owned and managed by a power company. Thus, we do not further consider the brute force strategy of adding extra storage just for V2G.

The second strategy, fleet management, draws V2G only from vehicles with known, fixed schedules. For example, a fleet of delivery vehicles might be in use 9:00 a.m. to 5:00 p.m. They could then predictably be used for V2G most or all of the remaining 16 h of the day. For example, our investigation with the grid operator in the Mid-Atlantic US (PJM) suggests that a garage of 100 fleet vehicles with 15 kW V2G could meet PJM's requirements of a 1 MW provider of regulation, with minimal or no need for rule changes (discussed subsequently). Another example might be a warehouse with forklifts, again operating on a predictable schedule. Although some warehouses operate almost continuously (with battery swapping), many others run forklifts for a single 8-h shift, or only once every several days according to bulk delivery schedules.

Fleets are good candidates for initial V2G installations, and our analysis suggests that their economics are very attractive. We discuss fleets further below with respect to business models and transition steps. Although the second strategy, using fleets, appears to be a good initial area for V2G, the combined markets for V2G are many times larger than total fleet vehicles. Thus, to realize the full potential of V2G, we need a third strategy so that non-fleet vehicles can also participate.

The third strategy is intelligent controls for complimentary needs. One central insight of our work on V2G is that the needs of the light vehicle operator and the grid operator are complementary. Their needs differ in time, predictability, and in the fundamental difference between energy and power. The vehicle operator needs stored energy in one particular vehicle at one fairly predictable time—when a trip begins. The grid operator needs power (instantaneous flow from a source or sometimes, to a sink), possibly at multiple times, but does not care which power plant (or which V2G vehicles) that power comes from. Most driving times are fairly predictable, regulation and spinning reserves calls are unpredictable.

One way to manage complementary needs is with a dashboard control that the driver could set according to normal or anticipated driving time and distance. Then, the on-board V2G control system could run V2G when needed by the grid operator, as long as the vehicle storage is always sufficient for the driver-specified trip at the driver-specified time. Some drivers may find that the “next trip” settings require too much planning and attention. If so, an alternative would be for the vehicle to “learn” driving patterns for, say, a few weeks before beginning V2G service. Then, the user controls could be simplified to a single button: an override.

For example, a driver expecting unusual trip times or expecting to drive longer than normal distances could push a 24-h override. In a fueled vehicle, the override would prohibit fuel use for V2G, while in a battery vehicle, it would charge at full speed whenever plugged in for the next 24 h. In either case, the override maximizes range at the cost of foregone V2G revenue for that 24 h time period. Some additional flexibility is possible with plug-in hybrids as long as the fuel storage is sufficient to meet driver-specified minimum range—the battery could swing from full to empty, as the plug-in hybrid can still operate on fuel only.

A rather different type of complementary need is between the grid operator and the home resident (often the same individual as the driver, but we are analyzing roles and needs). When grid power is down, the grid has no need for regulation or spinning reserves, but the homeowner wants emergency backup power. A time lag before power restoration—even the time lag of driving back home from an errand—is tolerable (more tolerable in homes than businesses).

Our preliminary calculations comparing employee shifts, vehicle parking intervals at work and lags to backup suggest that vehicles in commercial lots could not be relied on to meet fast-response commercial-level “24-7” backup power reliability, because, depending on shifts, there might not be sufficient vehicles on-site when grid power fails (this merits more systematic analysis, since commercial power failures cost an estimated 1% of GDP or US $100 billion/year in the US). Thus, we see the same equipment built for V2G as potentially also serving the home, but probably not commercial, emergency power.

Any EDVs, battery or fueled, could serve a few hours of emergency power (or days if restricted to refrigeration and a few lights); for long outages, fuel cell, and plug-in hybrids have the advantage of being able to be driven out to refuel. The duration and power that vehicle emergency power would provide can be computed using the equations for spinning reserves, above. Despite the expected merits of emergency power, we do not consider it further here.

Regarding V2G, the complementary-needs strategy—whether the driver sets a needed range or a smart vehicle learns driving patterns—results in the grid operator using aggregate V2G whenever needed, yet each vehicle is tapped only within the constraints of the driver's specified schedule and driving needs.

We now consider several business models for V2G. The business models are overlays on the strategies above, specifying the types of institutions and financial transactions that would make V2G profitable for a business. Under current rules, most large generators contract with the grid operators to provide spinning reserves or regulation, typically with a minimum of 1 MW quantities. During the time of that contract, the grid operator sends a signal when the electrical service is needed, and pays a single entity for the contract as well as for power actually generated (within vertically integrated utilities—which own generation, grid management and distribution—this power flows without market transactions, and often without any accounting of the true costs to provide it).

With V2G operating under these rules, if each vehicle provided 15 kW, a 1 MW contract would require 67 vehicles available. To allow some vehicles being low on fuel or charge, being maintained, or being in use off hours, we use a rough multiplier of 1.5. Thus, a fleet of 100 vehicles, 15 kW each, should be able to bid 1 MW contracts during non-driving hours.

A first business model, corresponding to the “fleet management” strategy above, is that the fleet operator sells V2G—the same party both manages time availability of fleet use for transportation and sells ancillary services directly to the grid operator. A single fleet in a single location simplifies the on-board electronics, and certified metering of power output would not be needed at the vehicle level, only for the fleet parking structure. To a grid operator accustomed to power plants feeding power into a single fixed location on the transmission network, a garage of vehicles looks more familiar and comfortable than dispersed vehicles. The fleet operator has a standard ancillary service contract and automatic generation control (AGC) controlled by the grid operator.

A second business model is to draw power from dispersed vehicles but within an existing business relationship. The obvious existing business relationship is with the retail power delivery company (the company known by consumers as “the electric utility”). This company could expand their business from selling retail electricity to also purchasing V2G power. They would contract to buy V2G from hundreds or thousands of individual vehicle owners and sell 1 MW blocks to the regional power market. The aggregator would have no direct control over operating schedules of individual vehicles, but would provide financial incentives to stay plugged in when possible. Power availability would be highly reliable in the statistical aggregate. The retail power delivery company would incorporate payments for V2G into the existing electricity billing, resulting in lower net payments from customers to the power delivery company. Correspondingly, the power delivery company would charge the regional power market (e.g., the regional ISO) for the aggregated V2G (e.g., as regulation). Here, the existing relationships with the customer and with the regional power market are leveraged for the new V2G product.

A third business model derives from the second—an independent party rather than retail power delivery company serves as the aggregator of individual vehicles. A number of parties might want to serve as aggregators: an automobile manufacturer or automotive service organization, who are increasingly using on-vehicle telematics to deliver information services between repairs; a battery manufacturer/distributor, who could provide “free battery replacement” for battery EDVs in exchange for reaping most or all of the profit from the V2G; a cell phone network provider, who might provide the communications functions and whose business expertise focuses on automated tracking and billing of many small transactions distributed over space and time—cell phone networking is a business similar to V2G in communications, control, value per transaction, and billing. Or, the aggregator could be a distributed generation manager, who today coordinates power from 5 to 10 small (100-500 kW) generators, and would extend this expertise to coordinate thousands of vehicles of 10-20 kW each. The former is now often coordinated via human-to-human telephone calls to 5 or 10 managers, whereas the switching on and off of individual vehicles for V2G, and commensurate billing, would of course be automated.

Regardless of business model, if there is a complementary needs strategy (either for a commercial fleet or for dispersed vehicles), we need to manage the vehicles' on-board storage. In management of power plants, “dispatch” refers to the timing and control of power plants, turning them on and off to match system needs. We extend the term here to refer to the same strategic control of vehicles in order to meet both driving needs and grid management needs.

For power plants, dispatch is based on operating costs, time required to come on-line, etc. For V2G dispatch of vehicles, in addition to the consideration of driver needs (expected next trip, etc.), an aggregator would also dispatch individual vehicles to maximize efficiency and minimize wear on the vehicles. These considerations lead to opposite dispatch strategies for vehicles with combustion engines (hybrid running in motor-generator mode) versus vehicles with electrochemical power plants (battery vehicles, fuel cell vehicles, and hybrids that are running V2G from battery only).

For vehicles with combustion engines (i.e., a hybrid providing V2G via motor-generator), optimum dispatch would be with each vehicle running at maximum power (given vehicle limits, such as cooling when stationary, power line capacity, etc.). This is because of the overhead of operating the prime mover, e.g., one motor running near full load (e.g. 15-25 kW) is more efficient than two running at one-half load or three running at one-third load. Running near full load maximizes electrical output unit of fuel consumed, and minimizes wear per unit electricity produced. Operationally, minimizing the number of combustion engines turned on at any one time may also improve safety and convenience. In choosing which vehicles to dispatch, per the complementary-needs strategy, dispatch would be in order of vehicles with the fullest tank first, or more precisely, dispatch first vehicles with the most fuel above the driver-anticipated need.

With electrochemical vehicles (battery and fuel cell), lower power levels both minimize wear and maximize efficiency. Battery wear is a function of kWh throughput, depth of discharge, and overheating (running high-current discharging or charging long enough to heat the battery, especially in hot weather). Fuel cell efficiency increases and wear decreases at lower current densities, although the latter is not yet fully investigated. Each of these factors militates for dispatch of many battery or fuel cell vehicles at partial load, rather than fewer vehicles at full load.

Dispatch would be managed somewhat differently for regulation and spinning reserves, and differently again for storage of intermittent renewable energy. In all these cases, the level of storage in the vehicle is being managed to match the power market. For the fueled vehicles (fuel cell and hybrid running motor-generator), the best strategy is always to have as much fuel as possible and does not require further discussion. Here, we discuss dispatch for battery vehicles (including plug-in hybrids running V2G from battery only), which offer additional opportunities.

For spinning reserves, having the battery storage filled is always best. For regulation, assuming that both regulation up and regulation down are being sold, a partially charged state is best. Fully charged, the vehicle cannot sell regulation down; empty, it cannot sell regulation up. Thus, one dispatch strategy upon returning from driving at a mid-charged level is for the vehicle to sell regulation up and down initially and then shift to straight charging or regulation down only, to charge the battery to prepare for the next trip. In fact, a simplified variant of V2G is regulation down only, as a means of obtaining revenue while charging. In electricity flow, regulation down only could be called “grid-to-vehicle” power, but the vehicle is in fact providing service to the grid. Thus, we refer to this case as V2G also. This charges at a substantially slower rate, specifically, at the ratio R_{d-c} , which we estimate to be about 8%.

The most important role for V2G may ultimately be in emerging power markets to support renewable energy. The two largest renewable sources likely to be widely used in the near future, photovoltaic (PV) and wind turbines, are both intermittent. Another solar electric source, central-tower concentrating, is now more economically competitive than PV for utility-scale generation, but is more geographically limited. It contains inherent storage of 2-4 h in the transfer fluid's thermal mass, so additional storage from V2G would be less important to this technology. At low levels of penetration, the intermittency of renewable energy can be handled by existing mechanisms for managing load and supply fluctuations.

However, as renewable energy exceeds 10-30% of the power supply, additional resources are needed to match the fluctuating supply to the already fluctuating load. Intermittency can be managed either by backup or storage. “Backup” refers to generators that can be turned on to provide power when the renewable source is insufficient. “Storage” has the advantage of additionally being able to absorb excess power, but adds the constraint that giving back power is duration-limited (as is absorbing it). In terms of V2G, backup can be provided by the fueled vehicles (fuel cell and hybrid running motor-generator). Storage can be provided by the battery vehicle and the plug-in hybrid running V2G from its battery. Hydrogen-powered fuel cell vehicles could be considered electrical storage, if the hydrogen is produced by electrolysis. Because of round-trip losses of conversions in the path electricity—electrolysis—hydrogen storage—small fuel cell—electricity, approximately 75% losses for electrolytic hydrogen versus 25% for battery, roundtrip electrolytic hydrogen appears to be too inefficient to be practical as storage.

The engineering distinction corresponds to relative economic advantage from shorter versus longer power flows and the difference between energy payment and capacity payment from Eq. (5), above. Next, we perform calculations to quantitatively evaluate V2G's potential for supporting intermittent renewable electricity. For illustration, we assume very large penetrations, e.g., PV providing most US peak power, and wind providing one-half of total US electrical energy. We express the US results as percentages of the vehicle fleet required, so our percentage results would be approximately the same across OECD countries with similar proportions of electricity to vehicle fleet size.

For PV, the solar resource has a fairly predictable daily cycle. The daily solar cycle precedes the load peak by a few hours—PV peak power is at solar noon, load peak is mid to late afternoon. Thus, a simple strategy to integrate PV into the grid is to meet peak load by storing from the solar peak to the load peak. The storage required for PV to be assured of meeting peak power needs is called the “minimum buffer storage requirement”, or MBSR. Current rules in California, for example, qualify PV as firm capacity, if there is MBSR of 0.75-1.0 h. Thus, to qualify a 1 MW solar PV plant as firm peak capacity would require 750 kWh to 1 MWh of V2G.

Calculating vehicle power output (P_{vehicle}) from Eq. (3) and assumptions above, a RAV4 EV could store or release 7 kW over a 1-h period. Thus, a 1 MW solar PV plant requiring 1.0 MSBR could be met with 143 RAV4s. At a national level, US electrical capacity is 811 GW (from Table 1, including utility and nonutility). Assuming that one-fifth were PV for peaking, at 1.0 MBSR, firm capacity credit would require 162 GW available from V2G. At 7 kW per vehicle, this could be met by 23 million V2G vehicles available, about 13% of the fleet; if we assume that only one-half of the contracted vehicles are available when needed, we would want 26% of the fleet under V2G contract.

Wind power is more complex. Wind fluctuates, and it cannot be turned up when electric demand increases. Some textbook treatments of wind describe storage as if it would be built and dedicated to match wind installations and their fluctuations. But this mechanistic dedicated storage approach does not reflect the ways in which electrical grids are already set-up to handle intermittency problems (power plant failures, fluctuations in load, etc.). In Table 8, we map textbook wind “storage intervals” in the first three columns, to our suggested match of each interval with electric markets and strategies, in the rightmost column.

Table 8 illustrates that existing markets apply precisely to storage interval 1 (regulation, some spinning reserves or intrahour adjustments), storage interval 2 (operating reserves), and to part of interval 3. Our ordering of the utility strategies for interval 3 is deliberate, that is, we expect that storage at this interval is minimized most economically by more widely spaced wind generation with transmission lines connecting them (discussed shortly), followed by operating reserves and load management (e.g., interruptible rates for industrial customers), followed by storage dedicated to the wind facilities only if needed after that point. Interval 4, seasonal mismatch between wind resources and load, would require huge purchases from operating reserve markets, or exceptionally large and cheap storage.

A more practical way to meet seasonal mismatch would be to shift load over the multi-decade implementation period, for example, if planned wind power exceeds demand in winter, incentives should be created for new and replacement furnaces to be shifted from fuel-burning to electric heat pumps. To quantitatively estimate the storage needs in terms of electric markets, we consider regulation and operating reserves. Then, as a check on those calculations, we develop an estimate of storage capacity needed for large-scale wind. Apart from time intervals, some storage must be optimized according to geography and transmission capacity. Specifically, for remote wind sites that require dedicated transmission, storage may be optimal at the wind site, because storage there not only smoothes out wind power fluctuations but also improves capacity factor of the power lines. V2G does not help with capacity of transmission lines from remote wind sites, as most vehicles are located close to loads.

For regulation, wind power increases the need for regulation. The need for regulation has been found in one estimate to be 0.5% and for load following to be 7.3% of wind capacity. Other estimates of regulation are 11% for small and 6% for large single wind installations. We have used the 6% figure to estimate regulation requirements, acknowledging that it may be high. From Table 1, US electric utility capacity is 811 GW (utility plus non-utility) at 57% capacity factor. To generate half of the electrical energy from wind at 33% capacity factor would require 700 GW of wind capacity (thus average wind output of 231 GW). Regulation at 6% would be 42 GW, which could be met by 2.8 million battery vehicles at 15 kW regulation per vehicle, or 1.6% of today's fleet (Table 1). Assuming only one-half of contracted vehicles are available for V2G at any one time, 3.2% of the light vehicle fleet would be on V2G contract for wind regulation.

Operating reserve needs for high-penetration wind include both spinning and non-spinning reserves, to cover all of interval 2 and part of interval 3 from Table 8. A thorough analysis uses the Strbac and Kirschen (SR) model is used by the electric industry to allocate the cost of operating reserves to specific generating plants within a mix of plants. In this model, the reserves are used to cover any shortfall between contracted generation and actual wind available—the storage needs are less stringent than those needed to guarantee constant baseload power from wind.

TABLE 8
Meeting wind storage needs with electric markets and strategic management

| Storage interval | Time range | Cause of fluctuation | Suggested electric market or strategy |
|---|---|---|---|
| 1 | Minute to hour | Gusts, weather | Regulation, some intrahour adjustments |
| | | | or spinning reserves |
| 2 | Hour to day | Weather and daily | Operating reserves (spinning and non- |
| | | thermal cycles | spinning reserves) |
| 3 | 1-4 days | Movement of fronts | Dispersion of wind resources with |
| | | | transmission; operating |
| | | | reserves; load management; dedicated |
| | | | storage (in |
| | | | sequence - see text) |
| 4 | Seasonal | Seasonal thermal and | Long-term match with of load (e.g., if |
| | | weather cycles | wind is stronger in winter, move space |
| | | | heating toward electric heat pumps |
| | | | rather than fossil fuel) |

Assuming dispersed wind generation and estimating some parameters not yet established for wind, the SR model may be used to estimate reserves need, arriving at a maximum of 11% of wind capacity (with “less reasonable assumptions” the maximum reserve need would be 20%). Assuming as above one-half of US electric energy coming from wind generators with capacity of 700 GW, the 11% reserve need would be 77 GW. We also assume here that the maximum duration for the reserve requirement would be 3 h. From the SR-operating reserve requirements (above), the number of EDVs to provide these operating reserves can be calculated.

For the fuel cell vehicle described by Eq. (3) and Table 2 above, power output per vehicle (P_{vehicle}) is 12 kW over 3 h. At 12 kW per vehicle, the 77 GW reserve requirement could be met by 6.4 million fuel cell vehicles, or again assuming only one-half are available and adequately fueled when called, 12.8 million vehicles under V2G contract, or 8% of the US fleet. For the battery vehicle, Eq. (3) yields 2.3 kW over a 3-h reserve requirement. Thus, to meet 77 GW would require 33.5 million battery vehicles or, assuming one-half available, 38% of the fleet needed under V2G contract.

Assuming a charge maintaining mode, the plug-in hybrid would provide 2.6 kW over 3 h; similarly assuming one-half available when needed, this would be met by 34% of the fleet under V2G contract (the battery or plug-in hybrid vehicles would also be able to absorb the excess power that a 700 GW wind system would sometimes produce—assuming the same 33.5 million battery vehicles (38% of fleet), with one-half available and each absorbing 7.0 kWh, the fleet could absorb 235 GWh). As shown in Eq. 3 and Table 2, the example plug-in hybrid would have too little battery charge left after a normal battery-depleting drive cycle to be useful. To illustrate possible hybrid use for wind backup, we assume that coming wind lulls would be forecast. Thus, 24-h before anticipated wind lulls, participating V2G hybrids would receive a control signal to drive in a “partial charge maintaining” mode, at the cost of burning more gasoline. We here assume that the partial charge minimum would be set at 60% battery capacity, which, after inverter losses, would be 7.8 kWh available from the 14.4 kWh battery.

As a check on the SR model, an alternative approach is to estimate the size of storage needed to insure a given minimum firm capacity. This mechanistic approach sizes storage dedicated to wind, rather than using electricity markets (and existing generation) for operating reserves. Again, we assume that to meet our benchmark of one-half of US wind generation, multiple widely distributed sites would be required. Wind speeds have been summed over a year from a distributed set of eight US Midwest sites in an ellipse approximately 500 km×400 km. The sum of wind power from eight sites approaches a normal distribution rather than a Rayleigh distribution, and never goes below 3 m/s for any 4 h block during the entire year. This study, and another one with mid-continental wind sites separated by 1600 km, both suggest far less storage needed for widely distributed wind sites than for single or nearby sites. However, neither reports the type of data we need to calculate storage requirements.

Here, we use data set based on the same eight sites. These data are disaggregated to hourly and add calculation of energy at each site, based on actual wind turbine performance (a GE 1.5 MW turbine at 80 m hub height), summed to yield hourly total energy for all sites combined. These data allow us to calculate directly the amount of storage needed for a distributed wind resource, which yields a transparent calculation, and does not require the SR model's assumption of electricity markets using existing generators. We assume storage would be used to maintain a 20% firm capacity (this level would be set by the wind seller; higher firm capacity values require more storage but increase revenue and make wind viable for a larger fraction of the generation mix). In the 6916 h of valid data, we find 1109 h in which the power was under 20% of rated capacity.

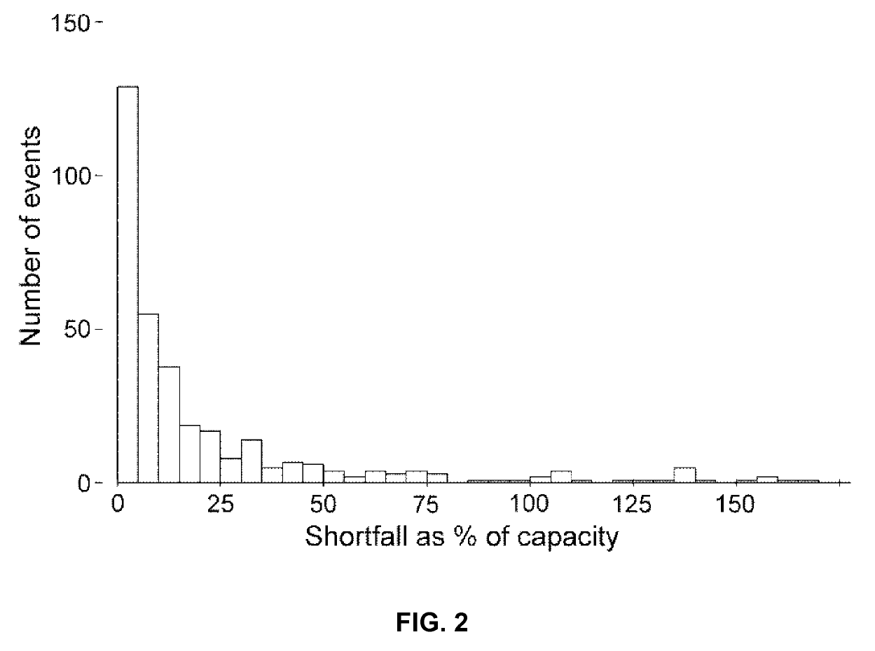

Grouping contiguous hours, we find 342 low-power events and compute the shortage in total MWh for each event, as shown in FIG. 2; 60% of these events are 2 h or less and require only 3-10% of capacity (e.g., MSBR of 0.03-0.1 h), easily handled by V2G. Storage need is determined by the worst cases; in FIG. 1, the worst cases are the rightmost cluster of five events with MWh shortfalls of about 170% of the MW wind turbine capacity. These five range from 14 to 22 h duration. In the solar energy backup metric, 170% is 1.7 h MBSR. We define “valid data” as having wind data from at least seven of the eight weather stations. The number of shortfalls is exaggerated by missing data. when we examine only hours with all eight weather stations available, we find only 122 shortfall events rather than 342, and only one of the above-mentioned five largest shortfalls. Since one of the largest events remains, correction for missing weather data would substantially reduce the number of events, but not significantly change the largest event, from which we calculate storage needs.

Taking our scenario of 700 GW wind capacity, 1.7 MBSR is 1190 GWh storage needed. Using the numerator of Eq. (3), the example fuel cell vehicle has available energy of 36 kWh from stored hydrogen and the plug-in hybrid 7.8 kWh from battery only. We assume that over a 14-22 h wind shortfall period, most vehicles would be driven; so, the plug-in hybrid would recharge from fuel as part of normal driving, or the fuel cell vehicle could refill with H2. Thus, we assume that three-fourths of the vehicles under V2G contract would be available over the 14-22 h shortfall period (rather than 50% assumed in prior examples). So, the storage need for 1190 GWh, would require 33 million fuel cell vehicles on-line (44 million on contract), or 152 million plugin hybrids (203 million on contract).

In a fleet of 176,000,000 vehicles, this becomes a need for V2G contracts with either 25% of the fleet of fuel cell vehicles or an impossible 116% fleet of plug-in hybrids (if the plug-in hybrid were allowed to run its motor-generator when parked during these long backup needs, the number of vehicles needed would be small, even less than for fuel cell vehicles, because of greater fuel storage). The battery vehicle is not suitable for these long storage intervals.

Although these illustrative calculations give the fleet percentage for only a single vehicle type, our analysis above suggest that optimum vehicle support for the pattern of shortfall events in FIG. 2 would be: (1) storage from battery or hybrid in battery mode for the most frequent and low-energy shortfalls and (2) backup from the fuel cell or hybrid in motor-generator mode, for the less frequent high energy shortfalls on the right of FIG. 2. The results for PV and wind are summarized in Table 9. Note that the two “firm capacity” calculations are more stringent in requiring dedicated storage, whereas the operating reserves calculation assumes taking advantage of existing generation and markets.

TABLE 9
V2G required to support large-scale renewable energy (see analysis in text)

| | | Renewable | | | | | |
|---|---|---|---|---|---|---|---|
| Renewable | Power type | capacity | | Support | | Vehicle | Fleet % needed, |
| type | and fraction | (GW) | Support criterion | quantity | | availability | vehicle type |
| Photo- | Peak (⅕ | 162 | Firm capacity | 162 | GW | ½ | 26% battery |
| voltaic | max load) | | (MBSR) | | | | |
| Wind | Baseload (½ | 700 | Regulation | 42 | GW | ½ | 3.2% battery |
| | energy) | | | | | | |
| | | | Operating | 77 | GW | ½ | 8% fuel cell, or |
| | | | reserves (SR) | | | | 38% battery, or |
| | | | | | | | 34% plug-in hybrid |
| | | | Firm capacity at | 1190 | GWh | ¾ | 23% fuel cell |
| | | | 20% (dedicated | | | | |
| | | | storage) | | | | |

This analysis, the above calculations summarized in Table 9, and indeed our opening Table 1, all suggest that V2G could play a role as storage for intermittent renewables, even when renewables become half (or more) of total electrical generation. V2G could be the critical missing piece of the system that enables intermittent renewable energy to provide much of society's energy needs, without large storage costs, while keeping the electric grid stable and reliable. In addition to the support of renewable energy, there are environmental and geopolitical benefits from operating the light vehicle fleet from domestic renewable energy—an understatement we do not quantitatively analyze here.

Initial V2G proof-of-concept, prototyping and device level testing has already been carried out and at least one V2G-capable controller for EDVs is commercially available. A V2G-capable vehicle has been designed, developed, built, driven, and extensively shop-tested by AC Propulsion, Inc., including an added wireless link to the grid operator, which has been tested over several months, in both driving and providing regulation up and down.

This single-vehicle demo has proven complete on-board V2G equipment, including real-time control by the grid operator, and multiple-connection-point provision of regulation from a mobile source.

We outline below a set of subsequent steps to implementation. The first and second steps will not occur with market forces alone, so some policy intervention is likely to be needed. First, we consider what types of vehicles are likely to initially be appropriate and affordable for demonstration use.

Of the three types of electric-drive vehicles we analyze, we determine which might be available in the near term for demonstrations, at reasonable prices at small production volumes. We briefly compare startup or low-volume costs for these three vehicle types.

Although hybrids are already in mass production, a shift to plug-in hybrids with all-electric range would require a fundamental redesign, not just adding a plug (e.g., a shift in mechanical:electrical power ratio from the current 3:1 to a lower-emission and more V2G-useful 1:3). But the close integration of the mechanical and electrical components makes the hybrid expensive to design. As an indicator, to recoup the development costs of their already-existing Prius® hybrid drive train, Toyota needs to sell 300,000 units per year. Some design, development, and testing of plug-in hybrids has been done, but no vehicles are yet scheduled for production.

To compare costs of fuel cell and battery vehicles, we review small-production runs from major manufacturers. The Honda fuel cell FCX is being leased in Japan for US $87,600/year, and Toyota leased two fuel cell vehicles in California for US $120,000/year. By comparison, 2 years earlier Toyota manufactured the battery-only RAV4EV, providing it initially for fleets at US $5484/year lease or US $42,000 outright purchase. Subsequently, with production at 300 per year, it sold battery-electric RAV4s to the public, also at US $42,000 outright sale, including a home charging station. Approximately, the same price has been quoted from a small manufacturer for a battery electric vehicle planned for 2005, using Li-Ion batteries and with 80-A V2G (19 kW) already built in.

We conclude that in small production runs (100-1000 s per year), battery vehicles with V2G would be in the range of 2× the cost of mass-produced gasoline vehicles, whereas fuel cell vehicles have so far been closer to 10×, and suitable plug-in hybrids, when available, would fall in between. Since the V2G control and business models of all the three vehicle types are similar, it would be reasonable to begin demonstration of V2G fleets with battery vehicles, regardless of whether one of the other types predominates in later years.

V2G will be unfamiliar to both electric system managers and to vehicle users. It will require full-scale, market participating demonstrations in order to work out problems and to educate the institutions and analysts involved. Since the technology development and above-mentioned single vehicle demo have been done already, what we describe as the first implementation step is implementation of demonstration fleets. A sufficiently sized fleet would allow real participation in grid management (by providing regulation or spinning reserves) and substantial revenue flows over a period of time. This will give fully real-world experience to both fleet managers and grid operators.

Initial fleets can draw from fabrication of V2G-capable EDVs in modest volumes, say, 100s to 1000s of vehicles per year. These volumes would be possible for a small company, by replacing the drive train of a mass-marketed vehicle (if a major auto manufacturer does assembly at this step, they too would likely produce 100s of vehicles in the same way, by refitting one of their mass-produced vehicles in a separate, smaller facility; this was how Toyota produced RAV4 EVs in multi-100 per year quantities).

A company-owned fleet operated primarily during a single shift would typically be parked in one parking area the remaining 16 h of the day, and would be reasonable for a Step 1 demonstration project. This would simplify management and control for V2G. A fleet of 100 vehicles at 15 kW each, even assuming only two-thirds available, could provide the 1 MW minimum of many current power supply contracts. Presuming exclusively battery electric vehicles at this stage (per cost and availability noted above), the regulation market would be the likely primary market. Regulation is needed 24 h per day, and unlike peak power is often needed as much overnight as during higher load hours. In these small production volumes, selling even high-value regulation would not cover the cost of vehicles. Nevertheless, a company and/or government might implement demonstration fleet(s) for the sake of: (1) technology leadership, (2) economic development, (3) to meet requirements on emissions, CO2 limitation, or clean fuels, or (4) for strategic reasons (e.g., to develop expertise in this area, to prepare for high fractions of renewable energy, to provide a local source of uninterruptible power, etc.).

As more fleets adapt V2G-capable vehicles, prices would be reduced with larger production volumes. Using a gasoline Taurus as a base, an estimate of costs of several comparable battery electric vehicles have been made. For a then—current (in 2001) NiMH battery with 90 miles range, the estimated retail cost is US $44,920 in limited production or US $28,034 in volume production. The volume price is still above the US $20,085 cost of the gasoline model. Given lower driving cost (electricity is cheaper than gasoline), the break even point would be when gasoline reaches US $4.19/gal (with then—current battery technology). With a more advanced Li-Ion battery with 140-mile range, and assuming longer shelf life than today's Li-Ion, the battery vehicle is estimated to have lower costs once gasoline exceeds US $1.27/gal (a price already surpassed as of this writing). Without considering V2G payments, which, at over US $2000/year tip the economics for the fleet operator further toward electric drive over gasoline.

In short, initial fleet adopters will pay a cost premium over gasoline vehicles, which the V2G payments would reduce but probably not eliminate. However, as the vehicles move to volume production and battery technology improvements continue, V2G payments shift the fleet operator's cost to breakeven with gasoline vehicles, then to lower costs.

Once fleets demonstrate viability and vehicle production volumes bring down cost, the V2G revenues may stimulate aggregators. They would aggregate smaller fleets and individual vehicles in the same utility control area. Because the number of vehicles is still relatively limited at this stage, getting enough in one grid “control area” may require local marketing or incentives (or a region with very high numbers of early adopters). Electricity markets served at this point might be predominantly regulation and spinning reserves, with peak power only in a few areas. Here, vehicle production might be expected to be 10s of 1000s of vehicles per year.

Step 2 begins at the point that costs drop below breakeven (with V2G revenue and fuel savings included) until the point that the high-value V2G markets of regulation and spinning reserves are saturated. We provide here the method for estimating saturation point, with representative calculations from one US state, California, which is comparable in size to a number of OECD countries. Assume vehicles with 15 kW capacity for V2G, and that on average only one-half are parked, plugged in, sufficiently charged, and participating in the program. A mid level of regulation of 1200 MW would be fully met by a fleet of (1200 MW/15 kW)×2=160,000 vehicles, or 0.9% of the California light fleet of 18,000,000 registered vehicles. To meet California's maximum regulation plus maximum spinning reserves contracts, totaling 4100 MW, again assuming 15 kW vehicles with one-half available at any one time, would be 547,000 vehicles, or 3% of California's fleet. As we approach 3% of the fleet under V2G contracts, the very high-value regulation market begins to saturate and the price of V2G drops.

As the implementation process approaches the time of saturation of the regulation and spinning reserves markets, the capital cost of electric-drive vehicles would be expected to be at or near parity with conventional internal combustion vehicles (on lifecycle cost), the revenue from selling V2G should be quite a bit lower per kWh than it was initially, and the total installed capacity of V2G, even in just one of the larger US states or OECD nations, would be in the GW. The high volumes of electric-drive vehicles will push vehicle prices down and permit a wider variety of vehicles, including plug-in hybrids and eventually perhaps fuel cell vehicles. The fraction of these three vehicle types will be determined by market forces in the vehicle market, and the V2G market should be prepared to utilize all three, whatever the fraction of each. Rather than a shift to one vehicle drive type, we expect that the market may shift to a diversity. Based on the new lithium battery technologies, the battery vehicles should have low operating cost and very low maintenance costs; the plug-in hybrid has the advantage of dual-fuel, electricity for low cost and home refuel convenience, or liquid fuel for fast-refueling and thus long-range trips. Market research conducted under contract by a consortium organized by EPRI suggests that there is a significant market for vehicles that can plug-in and have all-electric driving range, a feature absent from today's fuel-only hybrids.

Higher volumes of V2G capable vehicles and a more efficient aggregation industry have the benefits of making electric grid management cheaper, and making power more reliable and stable. They would also lead to the power plants now used for regulation and spinning reserves being freed up for base load, peak generation, renewable backup, or retirement. However, these conditions will put pressure on prices for V2G, lowering V2G rewards to drivers and profit margins to aggregators, thus, leading to a smaller proportion of V2G-capable vehicle owners opting to participate in V2G markets, and fewer being careful to stay plugged in. The large aggregate capacity and low unit cost of V2G at this phase is essential to the last market-storage for renewable energy.

Which jurisdictions (that is, nations, states, or provinces) might be expected to have earlier and greater interest in V2G implementation? Below we describe characteristics of jurisdictions that we would expect might motivate earlier V2G development. Such jurisdictions would:
1. Want electric grid improvements, higher reliability, and more frequency stability, but prefer to avoid construction of new power plants and transmission lines.
2. Be in geographic areas where a population of automobiles (e.g., a city or several fleets) is located on a peninsula with transmission constraints (e.g., Long Island, Del.), a grid-isolated island (e.g., Ireland), or an area with a fragmented grid (e.g., Australia).
3. Have high or moderate costs for regulation and spinning reserves. This includes most areas of the world, but not areas where hydropower provides most of the electricity, e.g., Brazil, Norway, or Washington (state in US).
4. Have competitive markets for regulation and spinning reserves, or alternatively, have some non-market ability to recognize or justify the value of providing these ancillary services.
5. Have policies or other encouragement for development of new industry, technology, or employment. For example, Step 1 of the suggested transition path involves small production facilities that provide local jobs immediately, although the vehicle costs would initially be above market.
6. Have a single or coordinated government units (state, nation, and ministry) with jurisdiction over both transportation and electricity. Additionally, jurisdictions with the following characteristics are more likely to see V2G as highly synergistic with wind development:
7. Have committed to growth of renewable energy and/or reduction of carbon dioxide emissions, and want to prepare for wind generation surpassing 20%.
8. Be in geographic areas where large auto fleets are located close to large wind resources. For example, such areas include the US East Coast, the United Kingdom or other western states of Europe. This criterion militates against regions whose wind resources are distant from population centers, such as the wind of Central Asia or the US Midwest. Jurisdictions with several of these characteristics are more likely to adopt V2G earlier.

Specifications of the power and communications requirements and cost estimates for adding V2G capability are described below. The current standards for power connection to vehicles were formulated with one-way flow in mind and are being updated to allow for V2G. The 1999 National Electrical Code, article 625, requires that “upon loss of voltage from the utility or other electric system(s), energy cannot be backfed”. Since this could be interpreted as prohibiting V2G, NEC 625 was revised in 2002 to allow feeding the grid “when intended” and more comprehensive standards for V2G are currently under discussion for NEC 625 as well as for SAE J2293 and IEEE P1547.

To evaluate power connections, it is useful to begin by comparing the desirable connections for V2G with the existing connections for battery electric vehicles (current, hybrid, and fuel cell vehicles do not have electrical connections). Most of the chargers for battery EDVs installed in the first California EV boomlet (through year 2002) are 7.7 kW (6.6 kW at commercial locations). The revised EV-charging standard by SAE allows up to 96 kW. Generally, conductive charging paths are preferred, but inductive coupling may be desirable in some circumstances, even though it is generally more complicated. and less efficient.

Vehicle connectors rated 20 kW are now commercially available, and V2G offers a substantial revenue increase if that original 7.7 kW maximum can be increased to the range around 15-20 kW. The following section analyzes plug connections in the 15 kW range, because typical house wiring, practicalities of grid-to-vehicle connections, and heating during continuous output from vehicles make 15 kW a reasonable upper limit to consider for analysis (for fuel cell vehicles, a little more, say 20 or 25 kW may be appropriate; higher values may be more likely at commercial locations than residences).

It is also illustrative to compare V2G connections with home electrical connections for generation, for example, home PV systems and emergency power. Both types of generation should be designed to consider utility worker safety. The danger is that lineworkers turn off the power source from the main power lines, but can receive a shock from electricity coming from a home PV or generator. Many local jurisdictions require that home power systems have approved safety interconnections. These include facilities, such as automatic lockout to prevent energizing utility lines that have been disconnected for service and automatic disconnection when voltage or frequency drift outside specified ranges. The approach to home power to date has been to have the interlock on the building. For vehicles, if they are to recharge at several locations, interlocks might more efficiently be incorporated into on-board electronics instead, as one manufacturer has already done. Here, we calculate cost based on this approach.

V2G requires electrical service to the parking site. Some locations would require electrical service upgrades to the residential or commercial building site (a higher capacity breaker box and possibly larger line to the power pole). In cost accounting, here we assume that a 6.6 or 7.7 kW line would be provided for a battery electric or plug-in hybrid, and no plug for a fuel cell vehicle. Thus, the V2G line upgrade costs would be 0, if the 6.6 kW line for BEV or plug-in hybrid were also used for V2G. In all other cases, costs are attributed to V2G; the entire costs of plugs on any fuel cell vehicle, or the incremental costs if a BEV or plug-in hybrid connection were upgraded from 6.6 to 15 kW or more. If an upgrade is being contemplated, our analysis is used to answer the question of whether the service upgrade would be justified based on the revenue from V2G. These cost estimates assume retrofit of a residential building, the highest cost situation. Costs would be dramatically lower if the V2G wiring were built into homes and commercial buildings from the start.

The initial step we suggest for V2G is for fleet vehicles. With commercial voltage at 208V, 15 kW lines in a parking structure would require an 80 A circuit (equivalent to the capacity of a hot tub with electric heating). A 20 kW line would require a 100 A circuit.

For a residential V2G line connection, in many or most single-family houses, a 40 A or 9.6 kW connection would be accommodated for the costs of wiring a socket. At 15 or 20 kW, a service upgrade is increasingly likely to be required.

Costs are highly site-specific. For wiring a new 50-70 A outside plug to a circuit box already having sufficient capacity, 40 ft. away, we estimate total cost of US $655. If a service upgrade (say, from 100 to 200 A) is required, the cost could increase by US $1000 up to as much as US $5000, mostly for labor, including permitting, shutoff, etc. For selling exclusively to the spinning reserves market, say a fuel cell vehicle that produces but cannot buy power, technically even a modest 100 A home service could accommodate over 20 kW and a 150 A over 30 kW, because unlike regulation, the current for spinning reserves would always flow vehicle-to-grid; thus, the V2G flow would always subtract from, not add to, the house loads (assuming building code and NEC approval). We have analyzed the V2G station cost, as if it were a NEC 625-compliant EV “charging station,” but we no longer consider this appropriate or necessary—battery and fueled vehicles are different, and V2G implies a need to rethink the best ways to achieve the connection's functions and failure modes.

These considerations make clear that no single definitive cost can be given. Based on the above, we assume US $1500 capital cost for a 15 kW residential connection for regulation or spinning reserves, installed as a retrofit. This is in the range of previously estimated costs of a plug (US $700-800) and off-board charger (US $300). For a commercial location, the cost would be substantially less.

We consider V2G communications to both a fleet and to dispersed vehicles. For a fleet parked in one location, managed as a collective, communications needs are simplified. Each parking space could have its telecommunications connection through a short-range, inexpensive, wireless protocol, such as Bluetooth. Only one precision certified meter is needed, at the grid connection to the whole parking lot, rather than certifying the V2G contribution of each individual vehicle.

For dispersed V2G sources, assuming an aggregator, a more general and long-distance communications link would be needed. This will be facilitated by a parallel but unrelated development—the automobile industry is making communications a standard part of vehicles. This field, called “telematics” has already begun with luxury vehicles; over a period of time, it will be available for most new car models. With telematics capability come services like mobile internet connectivity, real-time location, automated detection of mechanical problems matched to nearby facilities, location of nearest source of alternative fuels, and so on.

To allow for aggregators of dispersed V2G, and for several business models, we suggest five additions to electronic communication from the vehicle—a serial number for the vehicle, an electronic identification of which fixed (stationary) electric utility meter the vehicle is plugged into, an on-board certified meter, electronic verification that the vehicle is plugged in to a connection of known kW capacity, and an electronic “offer” and “acceptance” of a spot power contract. A unique vehicle identifier is essential for an aggregator of V2G to bill or credit to the correct vehicle. The vehicle must also tell the utility which fixed meter it is plugged into, information it could obtain either via an electronic meter number or query of the fixed-meter. For meters without electronic identification, the fixed meter could be identified by positioning (using a global positioning system (GPS) or using the directionality of the cell phone network).

A precision certified energy meter on-board enables a shift in the notion of what entity can be a utility account. The vehicle meter becomes a “metered account” whose power may be flowing through a fixed-location traditional meter (a “fixed-meter”). The billing system must take account of which fixed-meter the vehicle is plugged into, so that the mobile-meter energy can be added or subtracted to the amount registered on the fixed-meter to reconcile the fixed-meter's billing.

It is important to electronically verify the plug capacity and that the vehicle is plugged in. These are needed, because the high-value power markets we analyze achieve most of their revenue by being available and ready to provide power (capacity payments), rather than by energy payments.

As power enters the grid from dispersed individual residences, and especially if it becomes a large enough fraction that power flow through substations would be reversed, some limited upgrades (e.g., within substations) would be required and some additional communications and control would be desirable.

The electric utility industry is already planning for this eventuality due to a number of factors including distributed generation, and renewable energy, as well as V2G. We note progress both at the strategic level and with specific standards; the EPRI “Roadmap for the 21st Century” identifies as its first of three priorities “smart power”, which “will evolve to support dynamic two-way communication with advanced end-use devices, . . . , [including] two-way energy/information consumer access portals.” At the standards level, IEEE SCC211547 is setting standards for interconnecting distributed resources with electric power systems, while IEC 6185 is established object models for communication between substations and devices, a base usable for bidirectional power flow from V2G.

V2G may also be utilized to provide peak power for urban rail, intercity electric rail, or other industrial users with peak power requirements, either to allow higher peak power use than an existing utility connection can provide, or to reduce demand charges, or to eliminate separate billing items for ancillary services.

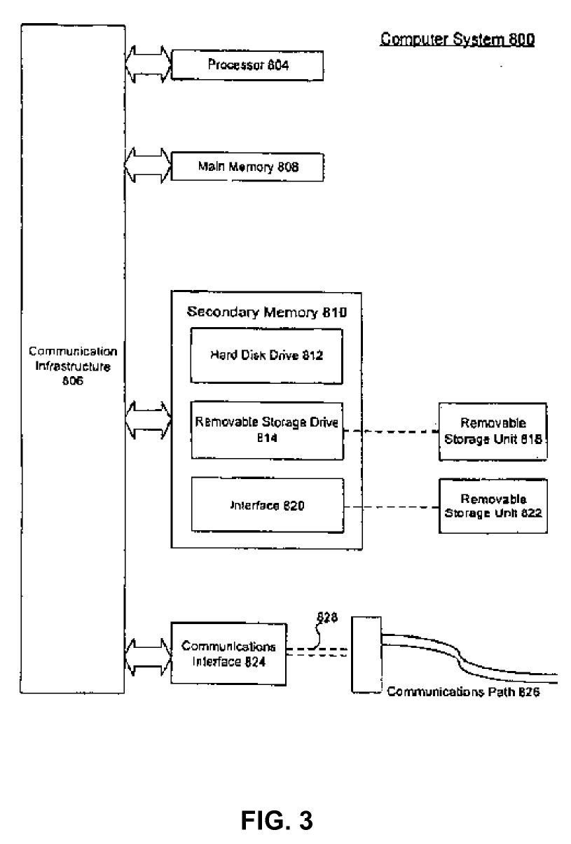

FIG. 3 notionally depicts a computer-based system 800 that may be used to aid in carrying out the method described above. Communication infrastructure 806 and communications interface 824 may also operate with a standard keyboard, display, and printer. Processor 804 may execute a computer program useful to carry out the analysis described above, by using, for example, a spreadsheet program.

TABLE A-1
Data needed for equations

| Parameter description | Symbol | Vehicle/market | Units |
|---|---|---|---|
| Line connection parameters | | | |
| Rated maximum circuit | A | | Amperes |
| Line voltage | V | | Volts |
| Vehicle parameters | | | |
| Stored energy (available to inverter) | Eₛ | | kWh |
| Vehicle efficiency | ηᵥₑₕ | | Miles/kWh |
| Efficiency of line AC to battery charge | η_{charger} | | Dimensionless |
| Efficiency of inverter from DC to line AC | ηᵢₙᵥ | | Dimensionless |
| Efficiency of converting fuel to electricity | η_{conv} | Fuel cell | kWh/kg H₂ |
| | | Battery | kWhₒᵤₜ/kWhᵢₙ |
| | | | (dimensionless) |
| | | Hybrid | kWh/gal |
| Lifetime | Lₕ | Fuel cell or | h |
| | | hybrid | |
| | L_{C} | Battery vehicle | Cycles (at given |
| | | | DoD) |
| Capital cost of prime mover | c_{engine} | Fuel cell or | $/kW |
| | | hybrid running | |
| | | motor-generator | |
| | c_{batt} | Battery | $ |
| Vehicle operational parameters | | | |
| Time plugged-in | t_{plug} | | h |
| Recharge since plugged in | E_{recharge} | | kWh |
| Distance driven | d_{d} | | Miles |
| Range buffer | d_{rb} | | Miles |
| Market parameters | | | |
| Dispatch to contract ratio | | Regulation | Dimensionless |
| Time for one dispatch^{a} | t_{disp} | | h |
| Price to sell V2G energy | pₑₗ | | $/kWh |
| Capacity price | p_{cap} | Regulation, spin | $/kW-h |
| Cost for EDV to buy energy | cₚₑ | | $/kWh, $/kg H₂, |
| | | | $/gal |

^{a}Maximum dispatch time for computing P_{vehicle}; average for computing E_{disp}

TABLE A-2
Variables calculated by the equations

| Description | Symbol | Units | Equation |
|---|---|---|---|
| Dispatch to contract ratio | R_{d-c} | Dimensionless | (1) |
| Power limit of line | Pₗᵢₙₑ | W (or kW) | (2) |
| connection | | | |
| Power limit of | P_{vehicle} | kW | (3) (3′) |
| vehicle's stored energy | | | |
| Total revenue | r | $ | (4), (5), (8) |
| Dispatched energy | E_{disp} | kWh | (6), (7) |
| Total cost per year | c | $/year | (9), (10) |
| Cost per energy unit | cₑₙ | $/kW | (11) |
| produced | | | |
| Degradation cost | c_{d} | $/kWh | (12)-(14) |
| Battery lifetime, in | L_{ET} | kWh | (15) |
| throughput | | | |
| Annualized capital cost | c_{ac} | $/year | (16) |

What is claimed as new and desired to be protected by Letters Patent of the United States is:

1. A method for calculating power available for sale from an electric vehicle to an electric power market on a grid, the method comprising:
determining maximum DC power available from the electric vehicle;
determining an electrical conversion efficiency related to a conversion of DC power from the electric vehicle to AC power;
accounting for a time period in which the DC power is available from the electric vehicle; and
calculating the power available for sale from the electric vehicle.

2. The method of claim 1, further comprising accounting for a difference in a current amount of stored energy and a full amount of stored energy in the electric vehicle.

3. The method of claim 1, further comprising accounting for a range buffer required by a driver of the electric vehicle.

4. The method of claim 1, wherein said calculating comprises calculating the power available for sale by using the equation
P_{vehicle}=[[Eₛ−(d_{d}+d_{rb})/ηᵥₑₕ]ηᵢₙᵥ]/t_{disp},
where P_{vehicle} is a maximum power from V2G in kW, Eₛ a stored energy available as DC kWh to an inverter, d_{d} a distance driven in miles since the energy storage was full, d_{rb} a distance in miles of the range buffer required by a driver, ηᵥₑₕ a vehicle driving efficiency in miles/kWh, ηᵢₙᵥ a dimensionless electrical conversion efficiency of a DC to AC inverter, and t_{disp} a time the vehicle's stored energy is dispatched in hours.

5. A method of assessing economic value of a vehicle to grid arrangement, the method comprising:
calculating a total revenue amount due to providing one or more of peak power, spinning reserves, and regulation services;
calculating a cost for each of producing energy, degradation due to wear, and annualized capitalization;
summing the calculated costs; and
determining the economic value of the vehicle to grid arrangement by comparing the summed calculated costs to the total revenue amount.

6. The method of claim 5, wherein revenue from spinning reserves and regulation services comprise a capacity payment and an energy payment.

7. A method of integrating a renewable energy source into an electrical power grid, the method comprising:
coupling the renewable energy source into the power grid;
connecting an electric vehicle having a vehicle to grid configuration to the power grid;
storing the coupled renewable energy in the electric vehicle.

8. The method of claim 7, further comprising providing one or more ancillary service to the electrical power grid subsequent to said step of storing.

9. The method of claim 7, wherein the renewable energy source comprises a wind turbine.

10. The method of claim 7, wherein the renewable energy source comprises a photovoltaic source.

11. The method of claim 7, wherein the one or more ancillary service comprises spinning reserves.

12. The method of claim 7, wherein the one or more ancillary service comprises a regulation service.

13. The method of claim 12, wherein the regulation service comprises providing regulation up.

14. The method of claim 12, wherein the regulation service comprises providing regulation down.

15. A method of integrating a plurality of vehicle to grid configured electric vehicles into an electrical grid, the method comprising:
contracting for the plurality of vehicle to grid configured electric vehicles to be connected to the electrical grid and available to provide services to the electrical grid during one or more agreed upon time periods;
accepting power from one or more of the plurality of electric vehicles during the one or more agreed upon time periods.

16. The method of claim 15, further comprising providing a peak power demand for one or more of urban rail, intercity electric rail, and an industrial user.

17. A computer-implemented system for assessing economic value of a vehicle to grid arrangement, the system comprising a computer circuit configured to:
calculate a total revenue amount due to providing one or more of peak power, spinning reserves, and regulation services;
calculate a cost for each of producing energy, degradation due to wear, and annualized capitalization;
sum the calculated costs; and
determine the economic value of the vehicle to grid arrangement by comparing the summed calculated costs to the total revenue amount.
